(19) United States
(12) Patent Application Publication
(10) Pub. No.: US 2026/0187138 A1
(43) Pub. Date: Jul. 2, 2026

(54) DECOUPLED QUERIES FOR END-TO-END 3D TRACKING USING TRANFORMER NEURAL NETWORKS

(71) Applicant: NVIDIA Corporation, Santa Clara, CA (US)

(72) Inventors: Yanwei LI, Nantong (CN); Zhiding YU, Santa Clara, CA (US); Jonah PHILION, Cupertino, CA (US); Anima ANANDKUMAR, Pasadena, CA (US); Sanja FIDLER, Toronto (CA); Jose M. ALVAREZ LOPEZ, Mountain View, CA (US)

(21) Appl. No.: 19/131,923

(22) PCT Filed: Sep. 30, 2023
(86) PCT No.: PCT/CN2023/123055

§ 371 Date: May 21, 2025

(51) Int. Cl. G06F 16/51; G06F 16/53; G06N 3/0499

(52) U.S. Cl. CPC G06F 16/51; G06F 16/53; G06N 3/0499

(57) ABSTRACT

In various examples, a technique for multiple object tracking is disclosed that includes generating, using one or more processing units, one or more first encoded image features based on a first image. The technique also includes generating a plurality of first object embeddings based on the first encoded image features, wherein at least one first object embedding of the plurality of first object embeddings corresponds to a different object depicted in the first image. The technique further includes determining, using a first track query of one or more track queries and one or more machine learning operations, a first association between a first track and a first object that corresponds to the at least one first object embedding, wherein the first track corresponds to the first track query. The technique further includes computing, based on the first association, an object trajectory associating the first track with the first object.

### BACKGROUND

An autonomous vehicle or semi-autonomous vehicle is equipped with a perception system that detects and tracks objects in the three-dimensional (3D) environment surrounding the vehicle. The perception system uses object detection and tracking techniques to detect and track objects in frames of a video sequence captured by one or more cameras. The objects can include vehicles, pedestrians, and other obstacles. Object detection techniques identify a position and a classification for each object in a frame. The position can be represented as a cuboid or bounding box that encloses the object, for example. Object detection can identify multiple instances of the same class of object, e.g., multiple humans in the same frame. Multi-object tracking (MOT) techniques identify tracks in a video sequence. MOT techniques can identify multiple instances of the same object identity, e.g., objects that are detected in different frames but are different views of a single object identity, such as a real-world object. MOT techniques associate each object that is an instance of the same identity with the same track. A track thus corresponds to an object identity and identifies instances of the object identity in different frames. A track can include frames in which the object is occluded. In addition to identifying tracks, object tracking techniques can operate in conjunction with object detection techniques to determine an identity, class, and bounding box for each object in a scene. However, prior object detection and tracking techniques can be inaccurate because of difficulties in detecting objects that are not clearly delineated from other objects and determining whether objects detected in different frames are instances of the same object identity.

Various approaches have been implemented to address object tracking limitations in autonomous or semi-autonomous vehicles. One type of approach is “tracking by detection,” which uses pre-defined three-dimensional (3D) detectors to identify positions of objects and use custom-tailored post-processing to track the objects. Tracking by detection uses motion models that focus on geometric cues, such as distance and 3D intersection over union comparisons, to determine whether two images depict the same object. Although tracking by detection performs well using input for distance-oriented sensors such as LiDAR, these techniques do not perform well on inputs from camera-based sensors.

Another type of approach uses machine learning to simplify the tracking pipeline and more effectively use appearance features from camera-based sensors to distinguish object identities. For example, transformer machine learning models may be used in multi-object tracking via a technique referred to as “tracking by query.” In particular, transformer-based MOT techniques represent each track using a transformer query referred to herein as a “track query.” The track query includes the identity of the associated object and the position of the object in one or more frames associated with the track query. Although transformer-based MOT techniques can be effective in the 2D domain, however, exhibit relatively poor detection and tracking accuracy when applied to the 3D domain.

Prior transformer-based approaches have relatively poor detection and tracking accuracy in the 3D domain because the prior approaches use a track query to represent both detection information for object detection tasks and tracking information for object tracking tasks. There is a conflict between the object detection task and the object tracking task that reduces the effectiveness of training the transformer networks. For object detection, the networks are trained to treat two track queries having the same object class as being similar, so two track queries having the same object class but different identities are treated as being similar in the object detection task. However, for object tracking, two track queries having the same object class should be treated as different objects if they have different identities. In prior art approaches, a transformer decoder network analyzes relationships between track queries, which allows for reasoning about the objects in a scene. However, using the same track query to represent identity-independent detection information and identity-dependent tracking information results in reduced object detection accuracy because the neural network has conflicting goals of object detection and object tracking. Since object tracking is dependent upon object detection, the reduction in detection quality also reduces the tracking quality. This reduced tracking quality is more prominent in the 3D domain than in the 2D domain.

As such, a need exists for more effective techniques for improving the accuracy of multi-object tracking.

### SUMMARY

Embodiments of the present disclosure relate to multiple object tracking using object queries and track queries. The techniques described herein include generating one or more first encoded image features based on a first image. The techniques also include generating one or more first object embeddings based on the first encoded image features, where each of the one or more first object embeddings corresponds to a different object depicted in the first image. The techniques further include determining, via one or more machine learning operations, a first association between a first track and a first object that corresponds to a first object embedding in the one or more first object embeddings using a first track query, where the first track corresponds to the first track query. The techniques further include generating, based on the first association, an object trajectory associating the first track with the first object.

One technical advantage of the disclosed techniques relative to the prior art is increased accuracy of object detection and tracking in the 3D domain as a result of using object queries for the object detection task and using track queries for the object tracking task. Unlike prior transformer-based approaches use a track query for both the object detection and object tracking tasks, the disclosed techniques use object queries in object detection networks for object detection and use track queries in object tracking networks for object tracking, thereby avoiding the task conflict. Accordingly, the disclosed techniques produce object tracking information that is more accurate than prior art approaches that use a track query to represent both the detection information and the tracking information.

### BRIEF DESCRIPTION OF THE DRAWINGS

The present systems and methods for multiple object tracking in autonomous or semi-autonomous systems and applications are described in detail below with reference to the attached drawing figures, wherein:

FIG. 1 illustrates a computing device configured to implement one or more aspects of various embodiments;

FIG. 2A illustrates an object tracking system that learns associations between objects and tracks, according to various embodiments;

FIG. 2B illustrates an object tracking example in which an object tracking system learns track-object associations for two images, according to various embodiments;

FIG. 3 illustrates a learnable association module, according to various embodiments;

FIG. 4 illustrates a temporal update module, according to various embodiments;

FIG. 5 illustrates a flow diagram of a method for object tracking using object queries and track queries, according to various embodiments;

FIG. 6 illustrates a flow diagram of a method for training an object tracking system, according to various embodiments;

FIG. 7A is an illustration of an example autonomous vehicle, in accordance with some embodiments of the present disclosure;

FIG. 7B is an example of camera locations and fields of view for the example autonomous vehicle of FIG. 7A, in accordance with some embodiments of the present disclosure;

FIG. 7C is a block diagram of an example system architecture for the example autonomous vehicle of FIG. 7A, in accordance with some embodiments of the present disclosure;

FIG. 7D is a system diagram for communication between cloud-based server(s) and the example autonomous vehicle of FIG. 7A, in accordance with some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

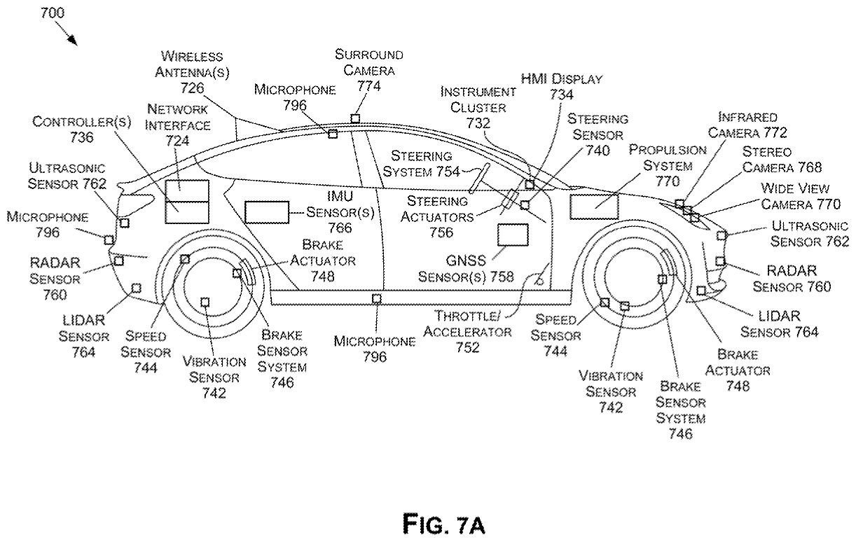

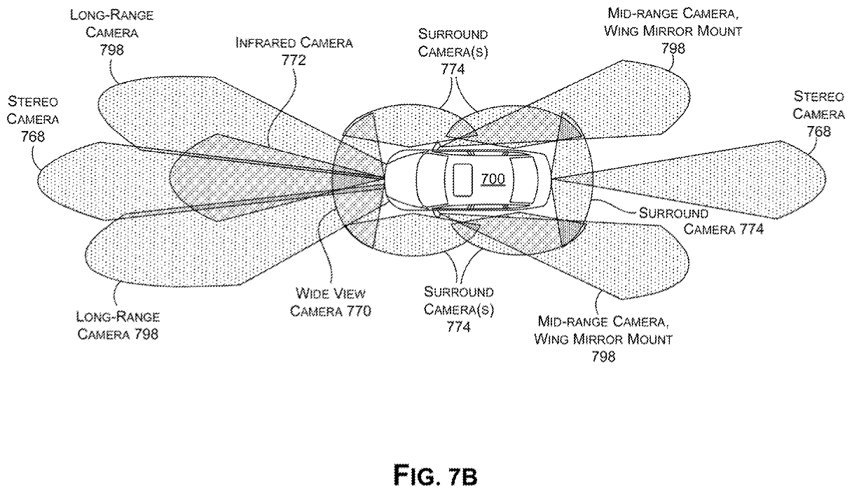

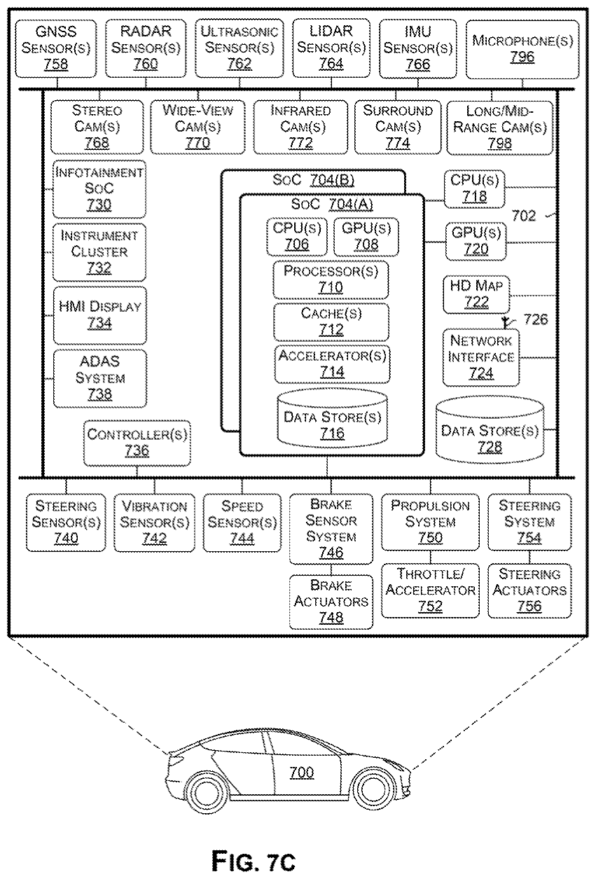

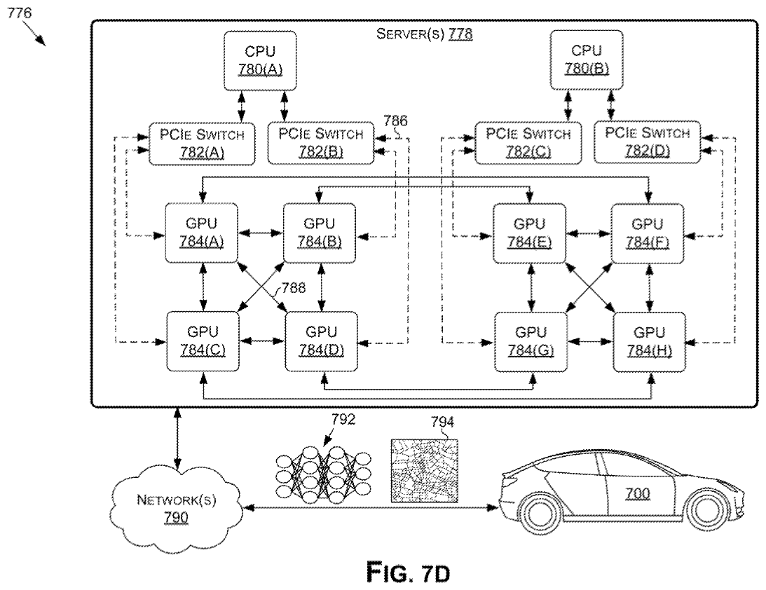

Systems and methods are disclosed for object tracking using decoupled queries. Although the present disclosure may be described with respect to an example autonomous or semi-autonomous vehicle or machine 700 (alternatively referred to herein as “vehicle 700” or “ego-machine 700,” an example of which is described with respect to FIGS. 7A-7D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to monitoring sensor performance in autonomous and/or semi-autonomous vehicles, this is not intended to be limiting, and the systems and methods described herein may be used in augmented reality, virtual reality, mixed reality, robotics, security and surveillance, autonomous or semi-autonomous machine applications, and/or any other technology spaces where sensor monitoring may be used.

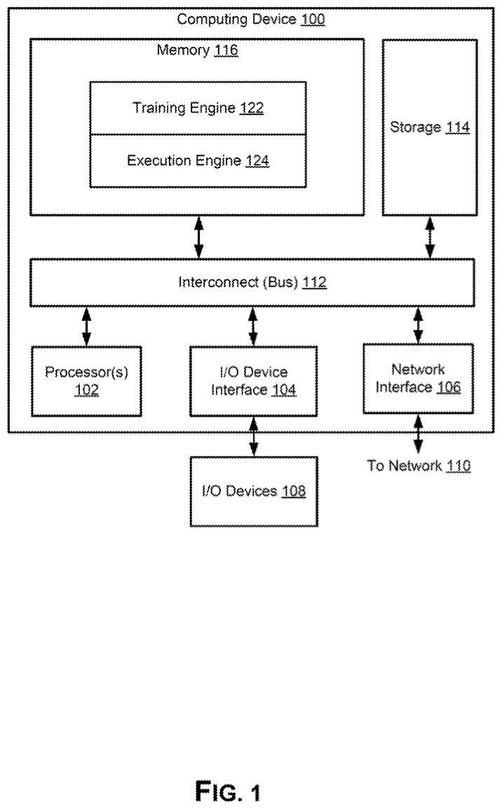

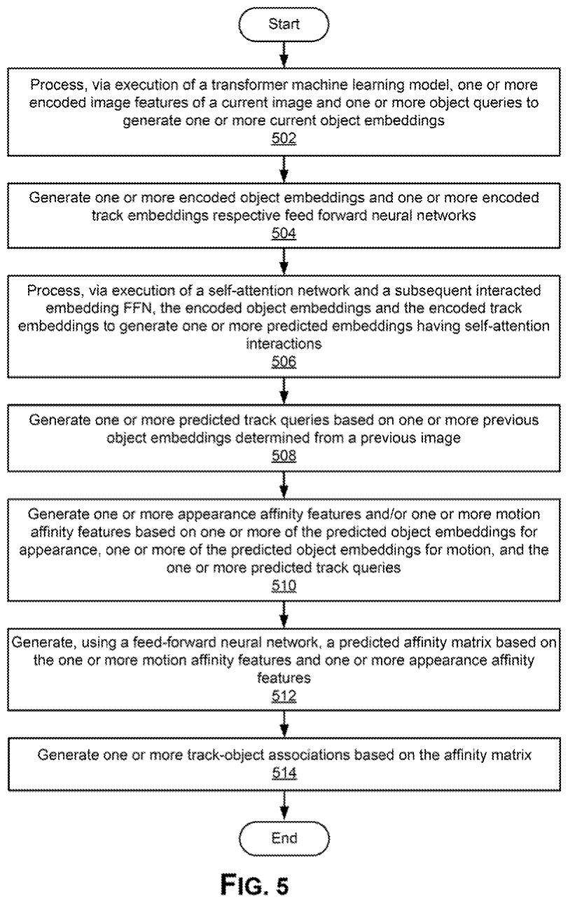

FIG. 1 illustrates a computing device 100 configured to implement one or more aspects of various embodiments. In at least one embodiment, computing device 100 includes a desktop computer, a laptop computer, a smart phone, a personal digital assistant (PDA), a tablet computer, a server, one or more virtual machines, an embedded system, a system on a chip, a computing system of an autonomous, semi-autonomous, or a non-autonomous machine, and/or any other type of computing device configured to receive input, process data, and optionally display images, and is suitable for practicing one or more embodiments. Computing device 100 is configured to run a training engine 122 and an execution engine 124 that may reside in a memory 116. It is noted that the computing device described herein is illustrative and that any other technically feasible configurations fall within the scope of the present disclosure. For example, multiple instances of training engine 122 and/or execution engine 124 may execute on a set of nodes in a distributed and/or cloud computing system to implement the functionality of computing device 100. Alternatively, computing device 100 may be implemented similar to that of the computing device of the example autonomous or semi-autonomous machine 700 described at least with respect to FIGS. 7A-5D.

In at least one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and/or a network interface 106. Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a deep learning accelerator (DLA), a parallel processing unit (PPU), a data processing unit (DPU), a vector or vision processing unit (VPU), a programmable vision accelerator (PVA), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing device 100 may correspond to a physical computing system (e.g., a system in a data center or a machine) and/or may correspond to a virtual computing instance executing within a computing cloud.

In at least one embodiment, I/O devices 108 include devices capable of receiving input, such as a keyboard, a mouse, a touchpad, a VR/MR/AR headset, a gesture recognition system, a steering wheel, mechanical, digital, or touch sensitive buttons or input components, and/or a microphone, as well as devices capable of providing output, such as a display device, haptic device, and/or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In at least one embodiment, network 110 is any technically feasible type of communications network that allows data to be exchanged between computing device 100 and internal, local, remote, or external entities or devices, such as a web server or another networked computing device. For example, network 110 may include a wide area network (WAN), a local area network (LAN), a wireless (e.g., WiFi) network, and/or the Internet, among others.

In at least one embodiment, storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and/or execution engine 124 may be stored in storage 114 and loaded into memory 116 when executed.

In one embodiment, memory 116 includes a random-access memory (RAM) module, a flash memory unit, and/or any other type of memory unit or combination thereof. Processor(s) 102, I/O device interface 104, and network interface 106 may be configured to read data from and write data to memory 116. Memory 116 may include various software programs or more generally software code that can be executed by processor(s) 102 and application data associated with said software programs, including training engine 122 and/or execution engine 124.

Training engine 122 and execution engine 124 include functionality to perform object tracking based on images in a sequence, such as frames of video sequences. More specifically, execution engine 124 is configured to generate object detection information, such as the positions and classes of objects, by providing object queries to a transformer decoder neural network. Each object query can have an initial value and can be a learned positional encoding. For each object query, the transformer decoder generates an object embedding based on the images, and the object embedding includes the object queries. The transformer decoder generates object detection results, such as an identity and position of each object, by transforming the object queries into object embeddings and then transforming the object embeddings into the object detection results using feed-forward networks (FFNs) or other suitable neural networks.

Training engine 122 trains neural networks that are used at inference time by execution engine 124 to perform the object detection and track detection described above. Training engine 122 uses ground truth data to train the neural networks based on amounts of loss determined by comparing object detection results and track detection results predicted by the neural networks to ground truth data.

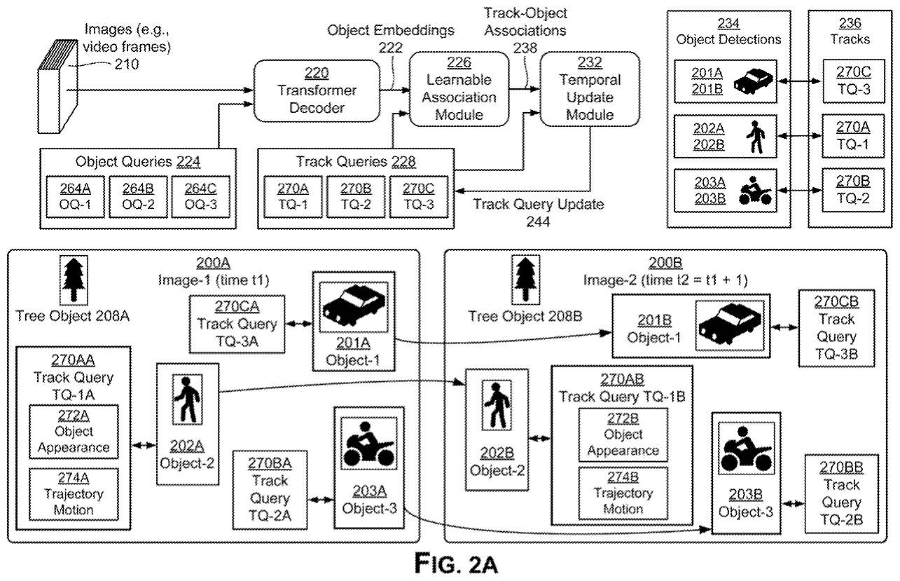

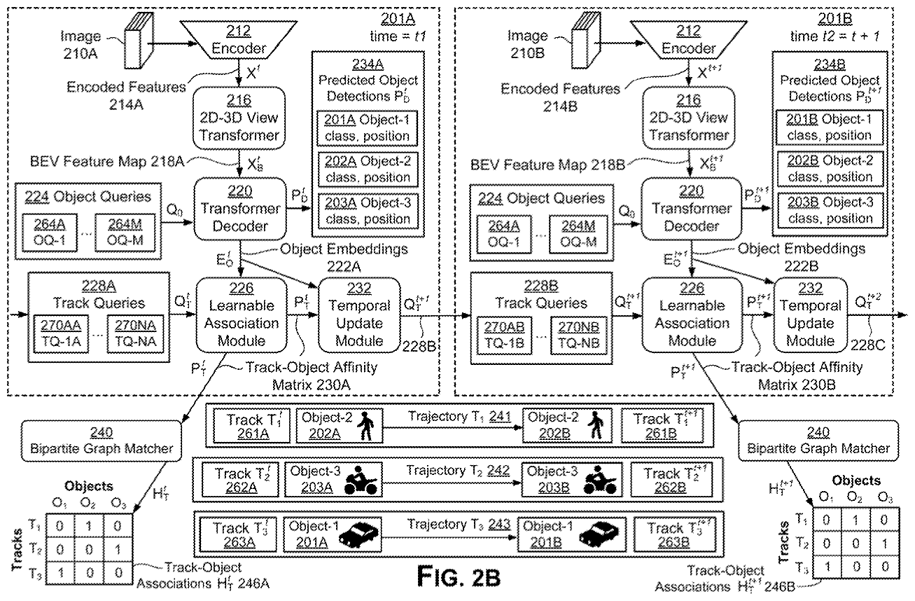

FIG. 2A illustrates an object tracking system that learns associations between objects 201 and tracks 263, according to various embodiments. The term “object” is used herein to refer to a region of an image 210 that depicts an instance of a particular class. The class can be, e.g., cars, people, trees, or other classification. The object tracking system includes a transformer decoder 220 that detects objects in one or more images 210 (e.g., video frames) by transforming one or more object queries 224 into object embeddings 222. Object embeddings 222 include encoded features representing objects 201 detected in one or more images 210. Although objects 201 can be represented using object embeddings 222, objects 201 can alternatively or additionally be represented using different data or a different data format than object embeddings 222. For example, an object 201 can be a set of numbers representing the positional coordinates and class of the object 201, or a pointer or other reference to an object embedding 222.

An image 210 depicts a particular instance of an object's identity. Each image 210 in a video sequence depicts a different instance of the object, for example. An object is an instance-specific representation of an object's identity. For example, an object 201A is an instance-specific representation in an image-1 200A of a car, and an object 201B is a different instance-specific representation in an image-2 200B of the same car. The objects 201A and 201B are instances of the same object identity, and the object identity corresponds to the particular car. An object identity can thus correspond to a real-world object such as a car.

The transformer decoder 220 uses a transformer neural network architecture and transforms one or more (e.g., M) object queries 224 using attention techniques, such as self-attention, to the object embeddings 222. The object queries 224 are learned positional encodings that are included in the input of each attention layer in the transformer decoder 220. The object embeddings 222 can be transformed to respective object detections 234 using one or more feed-forward networks (FFNs). The transformer decoder 220 has generated three object detections 234 in the example of FIG. 2A. The object detections 234 include a car object 201, a person object 202, and a motorcycle object 203. Each of the predicted object detections 234 includes a representation of the position of a detected object in the input image, e.g., the coordinates of a bounding box of the detected object 201, and also includes a class of the detected object 201, e.g., car, bus, pedestrian, and so on.

A number of object queries 224 are provided to the transformer decoder 220 as input, and the transformer decoder 220 can detect one object in an image 210 for each of the object queries 224. For example, if M object queries 224 are provided as input to the transformer decoder 220, then the transformer decoder 220 can detect up to M objects in an image 210. In the example of FIG. 2A, there are M=3 object queries 224, including an object query OQ-1 264A, object query OQ-2 264B, and object query OQ-3 264C. In other examples there can be hundreds of object queries 224, e.g., M=500 object queries 224. The transformer decoder 220 generates object embeddings 222 representing the detected objects. Each object embedding 222 includes encoded features representing an object that is depicted in an image 210. An object embedding 222 can include, for example, a bounding box of the position of the object in the image 210 and an object class (e.g., car, person, tree, or other classification).

A first example image 200A has a timestamp t1 and a second example image 200B has a timestamp t1+1. The first example image 200A depicts three detected moving objects 201A, 202A, 203A and a static (non-moving) object 208A. Three respective track queries 270AA, 270BA, 270CA are associated with the respective detected moving objects 201A, 202A, 203A in image 210A at time t1. A track query TQ-1A 270AA is associated with object-2 202A. The track query TQ-1A 270AA includes an object appearance 272A and trajectory motion 274A (e.g., a position of a bounding box of the associated object-2 202A). A track query TQ-2A 270BA is associated with object-3 203A, and a track query TQ-3A 270CA is associated with object-1 201A.

Each object 201, 202, 203 corresponds to a region of an image 200 that depicts an instance of a particular class. For example, a car object 201 corresponds to a car detected in an image 200A (at time t1), a person object 202 corresponds to a person detected in image 200A, and a motorcycle object 203 corresponds to a motorcycle detected in image 200A. Each object has an identity (e.g., a particular car for car object 201). The identity of each object is the same across different images 200A, 200B that depict instances of the object.

The second example image 200B depicts three detected moving objects 201B, 202B, 203B and a static (non-moving) object 208B. Three respective track queries 270AB, 270BB, 270CC are associated with the respective detected moving objects 201B, 202B, 203B in image 210B at time t2. The track query TQ-1B 270AB is associated with object-2 202B. The track query TQ-1B 270AB includes an object appearance 272B and trajectory motion 274B. The track query 270B is generated by updating track query 270A at time t1 based on information available at time t1. The updated track query TQ-2 270B for time t2 is predicted by the object tracking system based on information available at time t1, such as object detection information for the object-2 202A associated with track query TQ-1 270A. Track query TQ-1B 270AB is an updated version of track query TQ-1A 270AA and refers to the same object identity as track query TQ-1A 270AA. Accordingly, in each respective image 210A, 210B, each respective object 202A, 202B associated with respective track queries 270AA, 270AB is an instance of the same object identity (a person, for example). The person object 202 has moved from a position of object 202A in image 200A at time t1 to a position of object 202B in image 200B at time t2. Similarly, the car object 201 has moved from a position of object 201A in image-1 200A to a position of object 201B in image-2 200B, and the motorcycle object 203 has moved from a position of object 203A in image-1 200A to a position of object 203B in image-2 200B. The car object 201B in image-2 200B is associated with an updated version 270CB of the same track query 270CA associated with the car object 201A in image-1 200A, so car objects 201B and 201A are instances of the same object identity. The positions of car object 201A in image-1 200A and car object 201B in image-2 200B form a trajectory of car object 201.

A learnable association module 226 receives the object embeddings 222 and one or more track queries 228 as input. The learnable association module 226 determines, via one or more machine learning operations, an association between objects represented by the object embeddings 222 and tracks represented by the track queries 228. Each track query 270 in track queries 228 can include an object appearance (e.g., based on an object embedding) and trajectory motion information (e.g., a position of the object in an image 210). A track query 270 provides an association between object instances 201A, 201B in different frames 200A, 200B having the same object identity. In the example of FIG. 2A, there are N=3 track queries 228 for each image 210, including track query 228A, track query 228B, and track query 228C. The track queries generated for image-1 200A at time t1 are track query TQ-1A 228AA,

In various embodiments, the term “track” as used herein refers to tracking information that represents an object identity and can be updated based on successive frames to refer to or identify the object in each frame that is an instance of the object identity represented by the track. A track can be represented by a track query 228. Alternatively, a track can have a different representation than a track query. For example, a track 263 does not necessarily include the embedding of the identity and/or position of the object 201. A track can instead be represented using different data or a different data format than the corresponding track query 270. For example, a track can be any suitable representation of an object, such as numeric values representing the positional coordinates and object identity of the object 201.

In operation, the learnable association module 226 learns an association 246 between tracks 236 and detected objects 234 in each input image 210 of a video sequence. Each track 236 corresponds to an object identity. In the learned association, each track is associated with the object that has the same object identity corresponding to the track. If the same track appears in the association for two or more images 210 in a sequence of images, then the objects 234 associated with the same track for each image 210 have the same object identity. For example, the two car objects 201A, 201B associated with a track query 270C in different images 200A, 200B represent the same car object identity. Track query 270CB is an updated version of track query 270CA, so both objects 201A and 201B are associated with the same track query 270C. A track query 270C thus identifies a trajectory of an object 201 across images over time.

An example learned association is shown in FIG. 2A as a mapping between object detections 234 and tracks 236. In the example learned association, detected person objects 201A, 201B are associated with a track query TQ-3 270C. Since the detected car objects 201A, 201B are associated with track queries 270CA, 270CB, which are instances of the same track query 270C, detected objects 201A, 201B have the same object identity. Further, detected person objects 202A, 202B are associated with track queries 270AA, 270AB, which are instances of the same track query TQ-1 270A, so detected objects 202A, 202B have the same object identity. Still further, detected motorcycle objects 203A, 203B are associated with track queries 270BA, 270BB, which are instances of the same track query TQ-2 270B, so detected objects 203A, 203B have the same object identity.

A temporal update module 232 updates each track query 270 in track queries 228 based on object appearance and position information from a current input frame 200A to form an updated track query 270. The updated track query 270 is generated by the temporal update module 232 at a current time (e.g., t1) based on predicted appearance and position information that the updated track query 270 is expected to have at a future time (e.g., t2). Thus, the updated track query 270 for time t2 is predicted based on object appearance and position information available at the time the track query 270 is generated (e.g., t1). The object appearance and position information can be from transformer decoder 220, which performs object detection, for example. The object appearance and position information can be for the object associated with the current track query 270 at time t1. Information applied (e.g., averaged with) each track query 270 in the track queries 228A at a current time t1 to form track queries 228B for the next time t2 is shown as track query update 244, which is generated by the temporal update module 232. The temporal update module 232 also updates the object embeddings 222 based on each successive frame to more accurately represent each object at a current time. The temporal update module 232 updates the appearance and motion aspects of each track query 270 using prediction techniques based on the appearance and motion aspects of the object associated with the track query 270AA in the input image 210A to form the updated track query 270AB for the next input image 210B.

In various embodiments, in the case of a newly detected object not in a previous frame (e.g., image 210A), the temporal update module 232 initializes a track query 228 from a static object query. In the case of an object present in a previous frame, the temporal update module 232 updates a track query 228 based on an object embedding 222 from a previous frame (e.g., image 210A) in a sequence of frames. In various embodiments, there can be a track query 270 in a set of track queries 228 for each object detected in an image 210.

FIG. 2B illustrates an object tracking example in which an object tracking system learns track-object associations 246 for two images 210A, 210B, according to various embodiments. Operation of the object tracking system is shown at a time=t in box 201A and at a subsequent time=t+1 in box 201B. At time=t, as shown in box 201A, an image encoder 212 (“encoder”) receives an image 210A. The encoder 212 generates encoded features 214A, which are provided as input to a 2D-3D view transformer 216. The 2D-3D view transformer 216 transforms the encoded features 214A from 2D camera planes to either 3D space (e.g., a 3D volumetric feature map) or BEV (Bird's Eye View) space (e.g., a 2D BEV feature map). In various embodiments, 2D encoded features 214A from the image encoder 212 are lifted to 3D space to form a BEV feature map 218A through 2D-3D uplifting operations, such as forward projection, or backward projection methods (e.g., orthographic feature transform or deformable cross-attention). In the BEV feature map 218A, decoded object bounding boxes are in 3D as a result of regressing the x, y, and z coordinates of the box centers, the box 3D sizes, and the box orientations.

A transformer decoder 220 receives object queries 224 and transforms the object queries 224 to object embeddings 222A. Each of the object embeddings 222A represents an object that the transformer decoder 220 has detected in the image 210A. The transformer decoder 220 also transforms the object embeddings 222A to object detections 234A using one or more feed-forward neural networks or other suitable neural networks. The example object queries 224 include M object queries 264A-264M, where M specifies a configurable upper limit on the number of objects that the transformer decoder 220 can detect in the image 210A. The example object detections 234A include three detected objects 201A, 202A, 203A. Each detected object 201A, 202A, 203A includes a position (e.g., bounding box coordinates) and an object class.

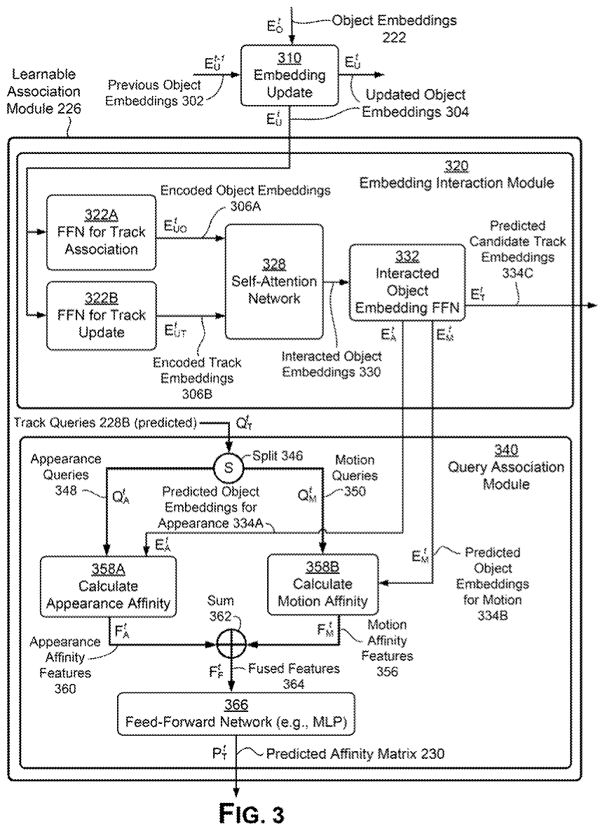

A learnable association module 226 receives the object embeddings 222A and a set of track queries 228A. The set of track queries 228A includes N track queries 270AA through 270NA, wherein N specifies a configurable upper limit on the number of tracks that the learnable association module 226 can identify in the image 210A. The learnable association module 226 generates a track-object affinity matrix 230A that associates each track-object pair with an affinity value indicating a degree of similarity between the track and the object. The track-object affinity matrix 230A is an N by M matrix, e.g., having N rows and M columns, in which the N rows correspond to tracks and the M columns correspond to objects. Each element of the matrix is a numeric affinity value that represents the affinity between a track that corresponds to the row of the element and an object that corresponds to the column of the element in the matrix. An affinity value can be between 0 and 1.0, for example, where 0 represents a low affinity, and 1.0 represents a high affinity between a track and object. In other embodiments, the affinity values in the matrix are represented by any suitable range of values. The learnable association module 226 is described in further detail herein with respect to FIG. 3.

A bipartite graph matcher 240 generates track-object associations 246A based on the track-object affinity matrix 230A. The track-object associations 246A associate each track with one of the objects detected in an image, such that an overall affinity of the track-object associations is maximized. In various embodiments, the bipartite graph matching can be performed using the Hungarian algorithm to find a matching in a weighted bipartite graph constructed from the affinity matrix 230A. In the weighted bipartite graph, a first set of nodes represents the tracks, a second set of nodes represents the objects, and the weights of edges between nodes in the first set and nodes in the second set are determined using the corresponding affinity values from the affinity matrix 230A. The bipartite graph matcher 240 finds a matching between the first and second sets of nodes in which the sum of weights is a maximum. In other embodiments, the affinity values can be on a scale for which 0 represents a high affinity, and 1.0 represents a low affinity, in which case the bipartite graph matcher 240 would find a matching in which the sum of weights is a minimum.

The track-object associations 246A for time=t are shown as a track-object association matrix. The matrix representation is an example, and any suitable representation of an association between tracks and objects can be used in other examples. In one example, a list of (track, object) pairs can be used instead of or in addition to the matrix representation of the track-object associations 246A. In the matrix representation of the track-object associations 246A, a value of 1 in a matrix element at a particular row and column indicates that the track and object represented by the row and column are associated. A value of 0 indicates that the track and object are not associated. In the matrix shown, the matrix element for track 1, object 2 is 1, which indicates that track 1 is associated with object 2. Similarly, the matrix element for track 2, object 3 has a value of 1, which indicates that track 2 is associated with object 3. Further, the matrix element for track 3, object 1 has a value of 1, which indicates that track 3 is associated with object 1. Thus, each track is associated with one of the objects. These track-object associations are shown in example trajectories 241, 242, 243. Trajectory 241 is for track-1 261 and object-2 202. For the track-object associations generated for time=t, trajectory 241 begins at the track-object association between track-1 261A and object-2 202A. Further, trajectory 242 begins at the track-object association between track-2 262A and object-3 203A, and trajectory 243 begins at the track-object association between track-3 263A and object-1 201A.

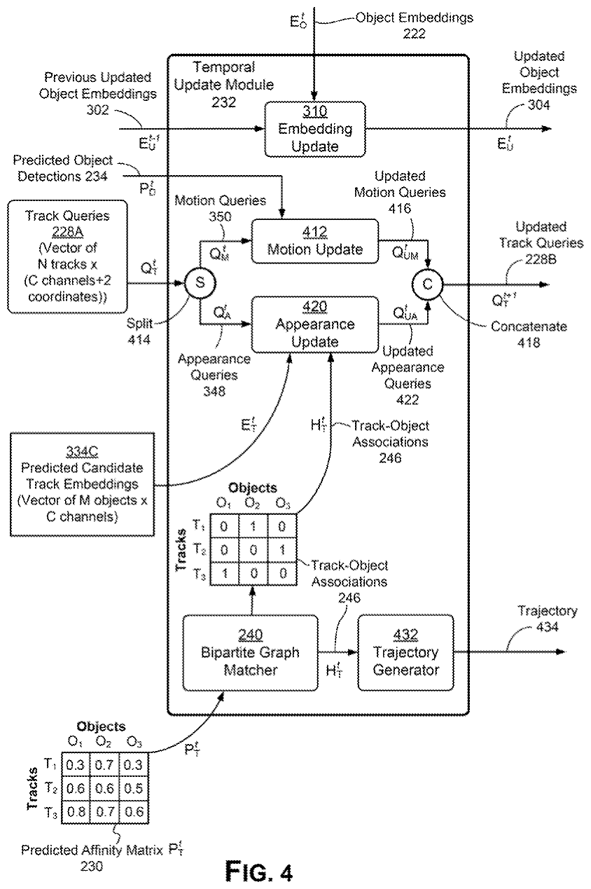

A temporal update module 232 updates the track queries 228A based on the object embeddings 222A generated for an input image 210 to form updated track queries 228B. The temporal update module 232 predicts updated appearance and motion aspects of each track query in the track queries 228A based on the current appearance and motion aspects of the object associated with the track query 228A. The current appearance and motion aspects of the object associated with each track query are specified in the object embeddings 222A received from the transformer decoder 220. The motion (e.g., object position) portion of each track query in the track queries 228 is updated based on a distance by which the object has moved since the previous update of the track query. The appearance portion of each track query in the track queries 228A is updated based on the particular embedding of the object that is associated with the track query by the track-object associations 246A. The updated track queries 228B, which include the updated appearance and motion portions, are used as input by the object tracking system when the next image (e.g., next frame) is processed. The temporal update module 232 is described in further detail herein with respect to FIG. 4.

At time=t+1, as shown in box 201B, encoder 212 receives image 210B. The encoder 212 generates encoded features 214B, which are provided as input to BEV space transformer 216. The BEV space transformer 216 transforms the encoded features 214B to a BEV feature map 218B, which is similar to the BEV feature map 218A but is based on the encoded features 214B. The transformer decoder 220 transforms object queries 224 to object embeddings 222B. The transformer decoder 220 also transforms the object embeddings 222B to object detections 234B using one or more feed-forward neural networks or other suitable neural networks. The example object queries 224 include M object queries 264A-264M, which can be the same as the object queries 224 that were provided to the transformer decoder 220 for the previous frame (at time=t). The example object detections 234B include three detected objects 201B, 202B, 203B. Each detected object 201B, 202B, 203B includes a position (e.g., bounding box) and class.

The learnable association module 226 receives the object embeddings 222B and updated track queries 228B at time=t+1. The updated track queries 228B are predicted by the temporal update module 232 based on the previous image 210A at a previous time=t (as shown in box 210A). The updated track queries 228B include N track queries 270AB through 270NB. The learnable association module 226 generates an N by M track-object affinity matrix 230B based on the object embeddings 222B and the updated track queries 228B as described above with respect to the track-object affinity matrix 230A at time=t. Each element of the matrix is a numeric affinity value that represents an affinity between a track and an object in the image 210B at time=t+1.

The bipartite graph matcher 240 generates track-object associations 246B at time=t+1 based on the track-object affinity matrix 230B. Track-object associations 246B for time=t+1 are shown as a matrix. The matrix representation of the track-object associations 246B at time=t+1 is the same as the track-object associations 246A at time=t in this example, since the same objects are present in images 210A and 210B. However, if the objects detected at time=t+1 were different from those at time=t, then the track-object associations 246B at time=t+1 could be different from the track-object associations 246A at time=t. In one example, even if the same objects are present at both times t=1 and t=t+1, if the transformer decoder 220 assigns different object numbers to the detected objects, then the track-object associations 246B could have values of 1 at different locations in the matrix.

The example track-object associations at time=t+1 are shown in example trajectories 241, 242, 243. For the track-object associations generated for time=t+1, trajectory 241 ends at the track-object association of updated track-1 261B and object-2 202B. Further, trajectory 242 ends at the track-object association of updated track-2 262B and object-3 203B, and trajectory 252 ends at the track-object association of updated track-3 263B and object-1 201B.

The track-object affinity matrix 230B is provided as input to temporal update module 232 and to a bipartite graph matcher 240. The temporal update module 232 predicts subsequent updated track queries 228C for use at time t2=t1+1 based on the updated track queries 228B, the object embeddings 222B, and the track-object affinity matrix 230B, as described in further detail herein with respect to FIG. 4.

FIG. 3 illustrates a learnable association module 226, according to various embodiments. As shown in FIG. 3, learnable association module 226 uses an embedding update 310 and includes an embedding interaction module 320 and a query association module 340.

The embedding update 310 generates updated object embeddings 304 by combining current object embeddings 222 produced by a transformer decoder 220 for a current image 210 with previous object embeddings 302 that were generated for a previous image 210 by a previous invocation of the embedding update 310. The embedding update 310 determines the updated object embeddings 304 as a weighted average of the previous object embeddings 302 and the current object embeddings 222. The weighted average can be determined by multiplying the previous object embeddings 302 by a decay rate B, multiplying the current object embeddings 222 by 1−B, and adding the products of the two multiplications. In various embodiments, the decay rate B can be an exponential moving average (EMA) or other moving average decay rate, for example.

The embedding interaction module 320 receives the updated object embeddings 304, which include embeddings that represent objects detected in an input image 210. The updated object embeddings 304 are processed by feed-forward networks 322A, 322B, which generate encoded object embeddings 306A and encoded track embeddings 306B, respectively. More specifically, the encoded object embeddings 306A are generated from the updated object embeddings 304 using the FFN for track association 322A. The encoded track embeddings 306B are generated from the updated object embeddings 304 using the FFN for track update 322B. In various embodiments, an encoded object embedding and an encoded track embedding each include an appearance embedding and a motion embedding. For example, in each encoded object embedding, the appearance embedding is C dimensional, where C is a number of channels that can be based on how many appearance-related features are encoded in the appearance embedding. As another example, the motion embedding is two dimensional, and encodes an (x, y) coordinate position in BEV space. An encoded object embedding can include an appearance embedding and/or a motion embedding. An encoded track embedding can include both an appearance embedding and a motion embedding.

The encoded object embeddings 306A and encoded track embeddings 306B are provided to a self-attention network 328 as input. The self-attention network 328 determines how much “focus” (e.g., weight) to place on each of the object and/or track embeddings received in the encoded object embeddings 306A and/or the encoded track embeddings 306B. The self-attention network 328 enhances relationships between objects that are represented by the encoded object embeddings 306A and/or between the encoded object embeddings 306A and tracks that are represented by encoded track embeddings 306B. The interacted object embeddings 330 generated by the self-attention network 328 are based on interactions in the self-attention network 328 between at least one first feature of a first object embedding in the encoded object embeddings 306A and one or more second object embeddings in the encoded object embeddings 306A. The self-attention neural network 328 can additionally or alternatively establish at least one additional relationship between at least one object in the encoded object embeddings 306A and at least one candidate track in the encoded track embeddings 306B. Thus, in the self-attention neural network 328, the encoded object embeddings 306A not only interact within themselves, but also interact with the encoded track embeddings 306B, thereby establishing the additional relationship(s). The additional relationship(s) improve the accuracy of query association predictions generated by the query association module 340. The self-attention network 328 can be a neural network that performs self-attention processing between embeddings that represent the object detections 234 in the encoded object embeddings 306A and the encoded track embeddings 306B.

As an example, each encoded object embedding 306A or encoded track embedding 306B can be represented as a vector of weights. If two objects, or an object and a track, have related motion, then a weight in the embedding of the object that represents a strength of relation to the other object or the track can be increased by the self-attention network 328. As such, a vector representing the object has been influenced in the self-attention network 328 by the other object or the track, and the embedding of the object has been enhanced by identifying the interaction between the two objects or between the object and the track, and enhancing the weight that represents the strength of the relation. The output of the self-attention network 328 is thus a set of such interacted object embeddings 330. The interacted object embeddings 330 can be a matrix that includes a row vector embedding each object, for example.

The embedding interaction module 320 processes the interacted embeddings 330 using the interacted embedding FFN 332, which adapts the dimensions of the interacted embeddings 330 to form predicted embeddings 334 having dimensions used by affinity calculators 358 in the query association module 340. The interacted embedding FFN 332 can also adjust the interacted embeddings 330 using weights learned during a training phase, so that the predicted embeddings 334 are generated by the interacted embedding FFN 332 based on the interacted embeddings 330 using the learned weights of the interacted embedding FFN 332.

The predicted embeddings 334 include predicted object embeddings for appearance 334A and predicted object embeddings for motion 334B. The predicted object embeddings 334A, 334B are provided to the query association module 340 as input for use in affinity calculations. Each of the predicted object embeddings for appearance 334A includes an appearance embedding, and each of the predicted object embeddings for motion 334B includes a motion embedding. The predicted embeddings 334 also include predicted candidate track embeddings 334C, which are provided to the temporal update module 232 as input. Each of the predicted candidate track embeddings 334C includes an appearance embedding and a motion embedding. The temporal update module 232 uses the predicted candidate track embeddings 334C to generate subsequent updated track queries 228C. More specifically, the temporal update module 232 uses the predicted candidate track embeddings 334C to update track queries 228 that are based on objects depicted in a current input image 210B, as described herein with respect to FIG. 4.

The query association module 340 determines affinities between tracks and objects and uses the affinities to predict a track-object affinity matrix 230. The query association module 340 receives the predicted object embeddings 334A, 334B, and also receives one or more predicted track queries 228B. The query association module 340 splits each of the track queries 228 into a set of appearance queries 348 and a set of motion queries 350 using a query splitter 346. Each track query 270 in the track queries 228 can include an appearance portion and a motion portion in a concatenated format. The appearance portion can be separated from the motion portion by the track query split 346. The appearance queries 348 can include the appearance portions of the respective track queries 228, and the motion queries 350 can include the motion portions of the respective track queries 228, for example.

The query association module 340 calculates one or more appearance affinity features 360 (e.g., appearance affinity values) based on the appearance queries 348 and the predicted object embeddings for appearance 334A. Each of the appearance affinity features 360 can be calculated as a Hadamard product of the respective appearance query 348 and the respective predicted object embedding for appearance 334A, for example. Further, the query association module 340 calculates one or more motion affinity features 356 (e.g., motion affinity values) based on the one or more motion queries 350 and the predicted object embeddings for motion 334B. Each of the motion affinity features 356 can be calculated as a geometric distance between the respective motion query 350 and the respective interacted object embedding for motion 334B. The geometric distance can be an L2 distance, for example.

The query association module 340 generates one or more fused features 364 as a sum of the appearance affinity features 360 and the motion affinity features 356 using an adder 362. The query association module 340 executes a feed-forward network 366 that generates a track-object affinity matrix 230 based on the fused features 364. The feed-forward network 366 can be a multi-layer perceptron (MLP), for example. Each matrix element in the track-object affinity matrix 230 specifies an affinity score representing an affinity between a track in a plurality of tracks and an object in a plurality of objects. The track can be associated with or represented as a track query, and the object can be associated with or represented as an object query.

FIG. 4 illustrates a temporal update module 232, according to various embodiments. As shown in FIG. 4, temporal update module 232 includes an embedding update 310, a motion update 412, an appearance update 420, a bipartite graph matcher 240, and a trajectory generator 432.

The temporal update module 232 generates a set of updated track queries 228B that include object appearance and position information. The updated track queries 228B are predicted by the temporal update module 232 based on one or more previous track queries 228A and information determined from a current image 210. The information determined from the current image 210 can include object detection information for the object associated with previous track queries 228A. The temporal update module 232 optionally performs an embedding update 310 to generate updated object embeddings 304 as described herein with reference to FIG. 3. In some embodiments, embedding update 310 is alternatively or additionally included in learnable association module 226, in which case embedding update 310 need not be included in temporal update module 232. The temporal update module 232 performs a motion update 412 and an appearance update 420 on each track query in a set of track queries 228 received as input. The results of the motion update 412 and the appearance update 420 are combined (e.g., concatenated) to form updated track queries 228B, which are output by the temporal update module 232 and can be used as input by the learnable association module 226 for a next image at a subsequent time.

Upon receiving a set of one or more input track queries 228A, the temporal update module 232 splits the track queries 228A into a set of motion queries 350 and set of appearance queries 348 using a splitter 414. For example, each track query can include a motion portion concatenated with an appearance portion. For each track query 270 in the track queries 228A, the splitter 414 identifies the motion portion and the appearance portion of the track query, then includes the motion portion and the appearance portion in a motion query and an appearance query, respectively.

A motion update 412 generates one or more updated motion queries 416 based on the motion queries 350 using a predicted velocity specified by a respective object embedding in the object embeddings 222. The updated motion queries 416 are generated by adding, to the position portion of each motion queries 350, a quantity determined by multiplying a time difference between the current frame (e.g., an image 210B at time t2) and a previous frame (e.g., an image 210a at time t1) by the predicted velocity.

Each of the motion queries 350 can include a position of the object associated with the motion query 350. The position can be specified as bounding box coordinates, for example. The temporal update module 232 updates the motion portion of each track query in the input track queries 228A based on a predicted velocity of the object associated with the track query. The predicted object velocity is determined by the transformer decoder 220 and can be retrieved from a corresponding object embedding in the object embeddings 222A. The corresponding object embedding corresponds to the track query that is being updated. The updated motion queries 416 are generated by adding, to the position portion of each motion queries 350, a distance determined by multiplying a time difference between the current frame and a previous frame by the predicted velocity. The time difference can be an amount of time elapsed since the previous update of the object position. The distance is added to the current position specified in the track query, and the resulting updated position is stored in the track query being updated.

The appearance update 420 generates one or more updated appearance queries 422 by updating each individual appearance query in the appearance queries 348 based on an appearance embedding portion of a selected candidate track embedding in the predicted candidate track embeddings 334C. The selected candidate track embedding is one of the predicted candidate track embeddings 334C that corresponds to the individual appearance query. More specifically, the selected candidate track embedding selected from the predicted candidate track embeddings 334C can correspond to an individual track query 270 (in the input track queries 228A) that contains the individual appearance query (e.g., from which the individual appearance query was determined using the splitter 414). In other words, given the predicted candidate track embeddings 334C, matched pairs can be selected according to the predicted affinity matrix 230. Since the number of objects M can be assumed to be less than the number of tracks N, the associated track-object pair 246 can be obtained from the predicted affinity matrix 230 using Hungarian matching. The particular candidate track embedding to be used to update the appearance queries 348 can be selected from the candidate track embeddings 344C using the associated track-object pair 246 as a selection criteria in an indexing operation performed on the candidate track embeddings 344C.

Accordingly, for each track query 270 in the input track queries 228A being updated, the appearance update 420 finds the associated object 201, which is the object 201 associated with the track query 270 by the track-object associations 246. As such, the temporal update module 232 identifies the object 201 associated with the track query 270 using the track-object associations 246, which map the track query 270 to the associated object 201. The track-object associations 246 can be generated from the track-object affinity matrix 230 using a bipartite graph matcher 240 as shown. The track-object associations 246 can be a matrix having a 1 in each element that which the corresponding track and object are associated. For example, the 1 at the intersection of the column labeled O2 and the row labeled T1 indicates that object O2 is associated with track T1. The 0 at the intersection of the column labeled O1 and the row labeled T1 indicates that object O1 is not associated with the track T1. The track-object associations 246 matrix is generated based on the track-object affinity matrix 230 using the Hungarian algorithm, for example, to find a one-to-one matching between tracks and objects in which the sum of the edges is a maximum (where the edges represent the affinity values between tracks and objects, and greater affinity values represent greater affinity or similarity).

The temporal update module 232 then selects the candidate track embedding of the associated object from the candidate track embeddings 344C and uses candidate track embedding to update the appearance portion of the track query. The resulting updated appearance queries 422 can be determined as a weighted average of the appearance portion of the track query and the candidate track embedding. The weighted average can be determined by multiplying the appearance query 348 portion of the input track query of the input track queries 228A by a decay rate A, multiplying the candidate track embedding by 1−A, and adding the products of the two multiplications. The decay rate A can be an exponential moving average (EMA) or other moving average decay rate, for example. The temporal update module 232 generates updated track queries 228B by concatenating the updated motion queries 416 with the updated appearance queries 422 using a concatenation 418. The updated track queries 228B are used as input track queries for the next frame.

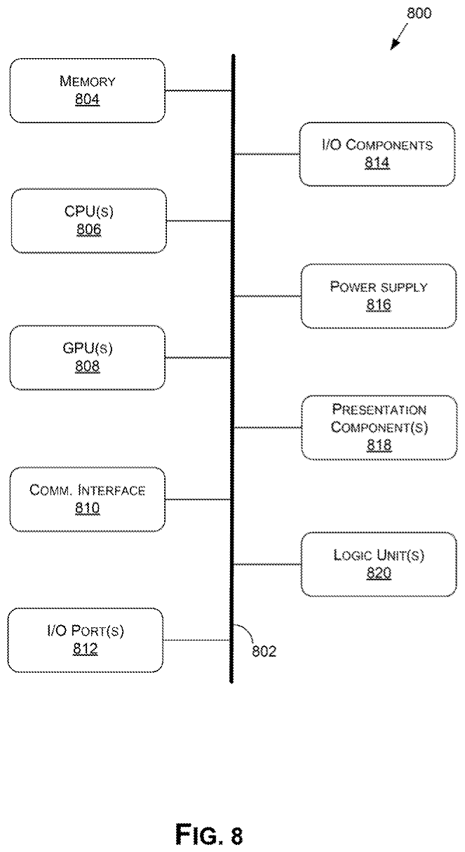

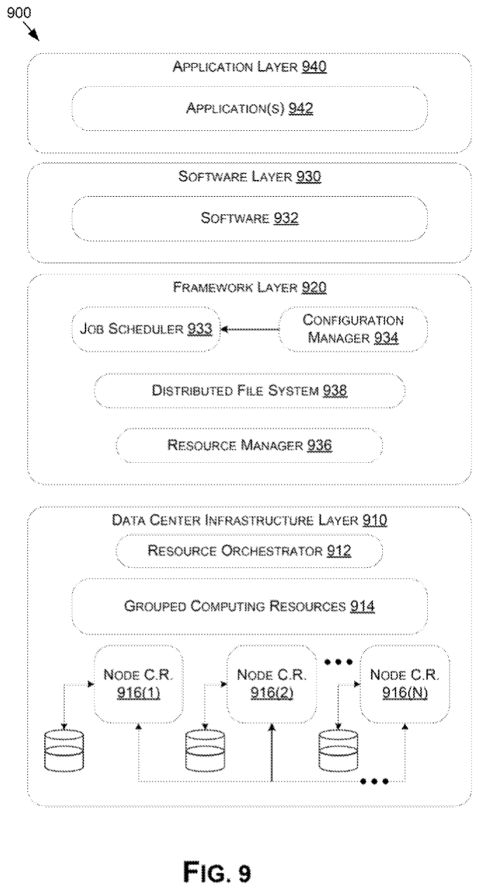

It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 700 of FIGS. 7A-7D, example computing device 800 of FIG. 8, and/or example data center 900 of FIG. 9.

Now referring to FIG. 5, each block of method 500, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 500 is described, by way of example, with respect to the system of FIGS. 1-4. However, this method may additionally or alternatively be executed by any one system, or any combination of systems, including, but not limited to, those described herein. Further, the operations in method 500 can be omitted, repeated, and/or performed in any order without departing from the scope of the present disclosure.

FIG. 5 illustrates a flow diagram of a method for object tracking using object queries and track queries, according to various embodiments. Although the method is described in conjunction with the systems of FIGS. 1-4, persons skilled in the art will understand that any system configured to perform the method steps in any order falls within the scope of the present disclosure.

As shown in FIG. 5, method 500 begins with operation 502, in which execution engine 124 processes, via execution of a transformer machine learning model, one or more encoded image features 214 of a current image 210 and one or more object queries 224 to generate one or more current object embeddings 222.

In operation 504, execution engine 124 generates one or more encoded object embeddings 306A and one or more encoded track embeddings 306B using respective interacted embedding FFNs 332A, 332B. Each object embedding 222 corresponds to one of the object queries 224 and includes a representation of a position of a respective object 10′ that is depicted in the image 210. For example, execution engine 122 can generate an object embedding 222 for each of the object queries 224. The representation of the position can be a bounding box of the respective detected object 201, for example.

In operation 506, execution engine 124 processes, via execution of a self-attention network 328 and a subsequent interacted embedding FFN 332, the encoded object embeddings 306A and the encoded track embeddings 306B to generate one or more predicted embeddings 334 having self-attention interactions.

In operation 508, execution engine 124 generates one or more predicted track queries 228B based on one or more previous object embeddings 222 determined from a previous image 210. In operation 510, execution engine 124 generates one or more appearance affinity features 360 and/or one or more motion affinity features 356 based on one or more of the predicted object embeddings for appearance 334A, one or more of the predicted object embeddings for motion 334B, and the one or more predicted track queries 228B. Each of the affinity features 356, 360 represents a degree of similarity between the respective predicted object embeddings 343A, 334B and the respective predicted track query 228B.

In operation 512, execution engine 124 generates, using a feed-forward neural network 366, a predicted affinity matrix 230 based on the one or more motion affinity features 356 and one or more appearance affinity features 360. In operation 514, execution engine 124 generates one or more track-object associations 246 based on the affinity matrix 230. The track-object associations 246 between tracks and objects can be used to perform multi-object tracking, since each track 236 is associated with a detected object of the object detections 234 of the same identity across images 210A, 210B.

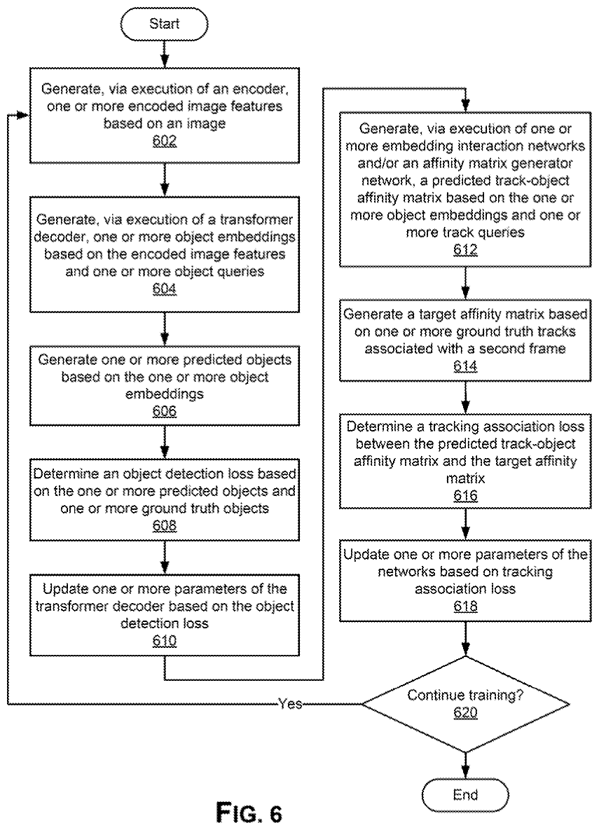

Now referring to FIG. 6, each block of method 600, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 600 is described, by way of example, with respect to the system of FIGS. 1-4. However, this method may additionally or alternatively be executed by any one system, or any combination of systems, including, but not limited to, those described herein. Further, the operations in method 600 can be omitted, repeated, and/or performed in any order without departing from the scope of the present disclosure.

FIG. 6 illustrates a flow diagram of a method for training an object tracking system, according to various embodiments. Although the method is described in conjunction with the systems of FIGS. 1-4, persons skilled in the art will understand that any system configured to perform the method steps in any order falls within the scope of the present disclosure. Training engine 122 uses supervised learning or other suitable training technique to optimize an object detection loss determined based on predicted object detections 234 and ground truth detections retrieved from training data for each image 210 and/or to optimize a tracking association loss determined based on predicted track-object affinity matrix 230 and ground truth tracks retrieved from training data for each image 210. Training engine 122 can perform supervision at each frame (e.g., each image 210).

As shown in FIG. 6, method 600 begins with operation 602, in which training engine 122 generates, via execution of an encoder 212, one or more encoded features 214 based on a current image 210. In operation 604, training engine 122 generates, via execution of a transformer decoder 220, one or more object embeddings 222 based on the encoded features 214 of the current image 210 and one or more object queries 224.

In operation 606, training engine 122 generates, via execution of a transformer decoder 220, one or more object detections 234 based on the one or more object embeddings 222 of objects depicted in the current image 210. In operation 608, training engine 122 determines an object detection loss based on the object detections 234 and one or more ground truth objects retrieved from or generated from training data. Training engine 122 uses a training pipeline from DETR (DEtection TRacking) 3D detectors and performs bipartite (e.g., Hungarian) matching for one-to-one target assignment. Therefore, a set-to-set approach of matching between a set of tracks and a set of objects is used to optimize the detection loss, including box regression and classification. Training engine 122 computes the object detection loss between the predicted object detections 234 and respective target ground truth object detections retrieved or generated from training data.

In operation 610, training engine 122 updates one or more parameters of the transformer decoder 220 based on the object detection loss. Training engine 122 updates weights of the transformer decoder 220 based on the object detection loss using an optimization technique such as backpropagation.

In operation 612, training engine 122 generates, via execution of one or more embedding interaction networks in embedding interaction module 320 and/or an affinity matrix generator feed-forward network 366, a predicted track-object affinity matrix 230 based on the one or more object embeddings 222 of objects depicted in the current image 210 and one or more track queries 228. In operation 614, training engine 122 generates a target affinity matrix based on one or more ground truth tracks associated with a different image 210, such as an image 210 that precedes or follows the current image 210 in a video sequence. Training engine 122 can retrieve the ground truth tracks associated with the different image from training data, for example. Further, training engine 122 finds the identity correspondence across the current image and the different image using the predicted track-object affinity matrix 230, as described herein with respect to FIG. 4.

In operation 616, training engine 122 determines a tracking association loss between the predicted track-object affinity matrix 230 and the target affinity matrix. The tracking association loss is calculated using a cross-entropy loss function, which calculates the tracking association loss between the predicted track-object affinity matrix 230 and the target affinity matrix 296. In operation 618, training engine 122 updates parameters (e.g., weights) of the networks being trained based on the tracking loss based on the tracking association loss using optimization techniques such as backpropagation.

In operation 620, training engine 122 determines whether or not training of the neural networks is to continue. For example, training engine 122 can determine that the transformer decoder 220, one or more of the neural networks in the embedding interaction module 320 (e.g., the FFN for track association 322A, the FFN for track update 322B, the self-attention network 328, and/or the interacted embedding FFN 332), and/or the feed-forward network 366 should continue to be trained using a detection loss, a tracking loss, and/or a cross-entropy regularization loss until one or more conditions are met. These condition(s) include (but are not limited to) convergence in the parameters of the transformer decoder 220 and/or one or more of the neural networks in the embedding interaction module 320, lowering of one or more of the detection loss, tracking loss, and/or cross-entropy regularization loss to below a threshold, and/or a certain number of training steps, iterations, batches, and/or epochs. While training of the neural network(s) continues, training engine 122 repeats steps 602 through 618 for subsequent images having associated ground truth detections and/or ground truth tracks, or at least the steps of method 600 that determine the loss(es) used in training the particular network(s) being trained. Training engine 122 then ends the process of training the neural network(s) once the condition(s) are met.

Training engine 122 could also, or instead, perform one or more rounds of end-to-end training of the transformer decoder 220, one or more of the neural networks in the embedding interaction module 320 (e.g., the FFN for track association 322A, the FFN for track update 322B, the self-attention network 328, and the interacted embedding FFN 332), and the feed-forward network (e.g., MLP) 366 to optimize the operation of all networks to the task of training the networks in the embedding interaction module 320 (e.g., networks 322A, 322B, 328, 332), and/or network 366 to generate object detections 234 and tracking associations (e.g., track-object affinity matrix 230 and/or track-object associations 246) that can be used to perform multiple-object detection and tracking.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Autonomous Vehicle

FIG. 7A is an illustration of an example autonomous vehicle 700, in accordance with some embodiments of the present disclosure. The autonomous vehicle 700 (alternatively referred to herein as the “vehicle 700”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 700 may be capable of functionality in accordance with one or more of Level 3-Level 7 of the autonomous driving levels. The vehicle 700 may be capable of functionality in accordance with one or more of Level 1-Level 7 of the autonomous driving levels. For example, the vehicle 700 may be capable of driver assistance (Level 1), partial automation (Level 2), conditional automation (Level 3), high automation (Level 4), and/or full automation (Level 7), depending on the embodiment. The term “autonomous,” as used herein, may include any and/or all types of autonomy for the vehicle 700 or other machine, such as being fully autonomous, being highly autonomous, being conditionally autonomous, being partially autonomous, providing assistive autonomy, being semi-autonomous, being primarily autonomous, or other designation.

The vehicle 700 may include components such as a chassis, a vehicle body, wheels (e.g., 2, 4, 6, 8, 18, etc.), tires, axles, and other components of a vehicle. The vehicle 700 may include a propulsion system 750, such as an internal combustion engine, hybrid electric power plant, an all-electric engine, and/or another propulsion system type. The propulsion system 750 may be connected to a drive train of the vehicle 700, which may include a transmission, to enable the propulsion of the vehicle 700. The propulsion system 750 may be controlled in response to receiving signals from the throttle/accelerator 752.

A steering system 754, which may include a steering wheel, may be used to steer the vehicle 700 (e.g., along a desired path or route) when the propulsion system 750 is operating (e.g., when the vehicle is in motion). The steering system 754 may receive signals from a steering actuator 756. The steering wheel may be optional for full automation (Level 7) functionality.

The brake sensor system 746 may be used to operate the vehicle brakes in response to receiving signals from the brake actuators 748 and/or brake sensors.

Controller(s) 736, which may include one or more system on chips (SoCs) 704 (FIG. 7C) and/or GPU(s), may provide signals (e.g., representative of commands) to one or more components and/or systems of the vehicle 700. For example, the controller(s) may send signals to operate the vehicle brakes via one or more brake actuators 748, to operate the steering system 754 via one or more steering actuators 756, to operate the propulsion system 750 via one or more throttle/accelerators 752. The controller(s) 736 may include one or more onboard (e.g., integrated) computing devices (e.g., supercomputers) that process sensor signals, and output operation commands (e.g., signals representing commands) to enable autonomous driving and/or to assist a human driver in driving the vehicle 700. The controller(s) 736 may include a first controller 736 for autonomous driving functions, a second controller 736 for functional safety functions, a third controller 736 for artificial intelligence functionality (e.g., computer vision), a fourth controller 736 for infotainment functionality, a fifth controller 736 for redundancy in emergency conditions, and/or other controllers. In some examples, a single controller 736 may handle two or more of the above functionalities, two or more controllers 736 may handle a single functionality, and/or any combination thereof.

The controller(s) 736 may provide the signals for controlling one or more components and/or systems of the vehicle 700 in response to sensor data received from one or more sensors (e.g., sensor inputs). The sensor data may be received from, for example and without limitation, global navigation satellite systems (“GNSS”) sensor(s) 758 (e.g., Global Positioning System sensor(s)), RADAR sensor(s) 760, ultrasonic sensor(s) 762, LiDAR sensor(s) 764, inertial measurement unit (IMU) sensor(s) 766 (e.g., accelerometer(s), gyroscope(s), magnetic compass(es), magnetometer(s), etc.), microphone(s) 796, stereo camera(s) 768, wide-view camera(s) 770 (e.g., fisheye cameras), infrared camera(s) 772, surround camera(s) 774 (e.g., 360 degree cameras), long-range and/or mid-range camera(s) 798, speed sensor(s) 744 (e.g., for measuring the speed of the vehicle 700), vibration sensor(s) 742, steering sensor(s) 740, brake sensor(s) (e.g., as part of the brake sensor system 746), and/or other sensor types. The controller(s) 736 may include one or more instances of fusion engine 122 and/or tracking engine 124 to monitor sensor performance based on the corresponding sensor data.

One or more of the controller(s) 736 may receive inputs (e.g., represented by input data) from an instrument cluster 732 of the vehicle 700 and provide outputs (e.g., represented by output data, display data, etc.) via a human-machine interface (HMI) display 734, an audible annunciator, a loudspeaker, and/or via other components of the vehicle 700. The outputs may include information such as vehicle velocity, speed, time, map data (e.g., the High Definition (“HD”) map 722 of FIG. 7C), location data (e.g., the vehicle's 700 location, such as on a map), direction, location of other vehicles (e.g., an occupancy grid), information about objects and status of objects as perceived by the controller(s) 736, etc. For example, the HMI display 734 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 700 further includes a network interface 724 which may use one or more wireless antenna(s) 726 and/or modem(s) to communicate over one or more networks. For example, the network interface 724 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 726 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 7B is an example of camera locations and fields of view for the example autonomous vehicle 700 of FIG. 7A, in accordance with some embodiments of the present disclosure. The cameras and respective fields of view are one example embodiment and are not intended to be limiting. For example, additional and/or alternative cameras may be included and/or the cameras may be located at different locations on the vehicle 700.

The camera types for the cameras may include, but are not limited to, digital cameras that may be adapted for use with the components and/or systems of the vehicle 700. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 700 (e.g., front-facing cameras) may be used for surround view, to help identify forward facing paths and obstacles, as well aid in, with the help of one or more controllers 736 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 770 that may be used to perceive objects coming into view from the periphery (e.g., pedestrians, crossing traffic or bicycles). Although only one wide-view camera is illustrated in FIG. 7B, there may be any number (including zero) of wide-view cameras 770 on the vehicle 700. In addition, any number of long-range camera(s) 798 (e.g., a long-view stereo camera pair) may be used for depth-based object detection, especially for objects for which a neural network has not yet been trained. The long-range camera(s) 798 may also be used for object detection and classification, as well as basic object tracking.

Any number of stereo cameras 768 may also be included in a front-facing configuration. In at least one embodiment, one or more of stereo camera(s) 768 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 768 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 768 may be used in addition to, or alternatively from, those described herein.

Cameras with a field of view that include portions of the environment to the side of the vehicle 700 (e.g., side-view cameras) may be used for surround view, providing information used to create and update the occupancy grid, as well as to generate side impact collision warnings. For example, surround camera(s) 774 (e.g., four surround cameras 774 as illustrated in FIG. 7B) may be positioned to on the vehicle 700. The surround camera(s) 774 may include wide-view camera(s) 770, fisheye camera(s), 360 degree camera(s), and/or the like. Four example, four fisheye cameras may be positioned on the vehicle's front, rear, and sides. In an alternative arrangement, the vehicle may use three surround camera(s) 774 (e.g., left, right, and rear), and may leverage one or more other camera(s) (e.g., a forward-facing camera) as a fourth surround view camera.

Cameras with a field of view that include portions of the environment to the rear of the vehicle 700 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 798, stereo camera(s) 768), infrared camera(s) 772, etc.), as described herein.

FIG. 7C is a block diagram of an example system architecture for the example autonomous vehicle 700 of FIG. 7A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 700 in FIG. 7C are illustrated as being connected via bus 702. The bus 702 may include a Controller Area Network (CAN) data interface (alternatively referred to herein as a “CAN bus”). A CAN may be a network inside the vehicle 700 used to aid in control of various features and functionality of the vehicle 700, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 702 is described herein as being a CAN bus, this is not intended to be limiting. For example, in addition to, or alternatively from, the CAN bus, FlexRay and/or Ethernet may be used. Additionally, although a single line is used to represent the bus 702, this is not intended to be limiting. For example, there may be any number of busses 702, which may include one or more CAN busses, one or more FlexRay busses, one or more Ethernet busses, and/or one or more other types of busses using a different protocol. In some examples, two or more busses 702 may be used to perform different functions, and/or may be used for redundancy. For example, a first bus 702 may be used for collision avoidance functionality and a second bus 702 may be used for actuation control. In any example, each bus 702 may communicate with any of the components of the vehicle 700, and two or more busses 702 may communicate with the same components. In some examples, each SoC 704, each controller 736, and/or each computer within the vehicle may have access to the same input data (e.g., inputs from sensors of the vehicle 700), and may be connected to a common bus, such the CAN bus.

The vehicle 700 may include one or more controller(s) 736, such as those described herein with respect to FIG. 7A. The controller(s) 736 may be used for a variety of functions. The controller(s) 736 may be coupled to any of the various other components and systems of the vehicle 700, and may be used for control of the vehicle 700, artificial intelligence of the vehicle 700, infotainment for the vehicle 700, and/or the like.

The vehicle 700 may include a system(s) on a chip (SoC) 704. The SoC 704 may include CPU(s) 706, GPU(s) 708, processor(s) 710, cache(s) 712, accelerator(s) 714, data store(s) 716, and/or other components and features not illustrated. The SoC(s) 704 may be used to control the vehicle 700 in a variety of platforms and systems. For example, the SoC(s) 704 may be combined in a system (e.g., the system of the vehicle 700) with an HD map 722 which may obtain map refreshes and/or updates via a network interface 724 from one or more servers (e.g., server(s) 778 of FIG. 7D).

The CPU(s) 706 may include a CPU cluster or CPU complex (alternatively referred to herein as a “CCPLEX”). The CPU(s) 706 may include multiple cores and/or L2 caches. For example, in some embodiments, the CPU(s) 706 may include eight cores in a coherent multi-processor configuration. In some embodiments, the CPU(s) 706 may include four dual-core clusters where each cluster has a dedicated L2 cache (e.g., a 2 MB L2 cache). The CPU(s) 706 (e.g., the CCPLEX) may be configured to support simultaneous cluster operation enabling any combination of the clusters of the CPU(s) 706 to be active at any given time.

The CPU(s) 706 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 706 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 708 may include an integrated GPU (alternatively referred to herein as an “iGPU”). The GPU(s) 708 may be programmable and may be efficient for parallel workloads. The GPU(s) 708, in some examples, may use an enhanced tensor instruction set. The GPU(s) 708 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 712 KB storage capacity). In some embodiments, the GPU(s) 708 may include at least eight streaming microprocessors. The GPU(s) 708 may use compute application programming interface(s) (API(s)). In addition, the GPU(s) 708 may use one or more parallel computing platforms and/or programming models (e.g., NVIDIA's CUDA).

The GPU(s) 708 may be power-optimized for best performance in automotive and embedded use cases. For example, the GPU(s) 708 may be fabricated on a Fin field-effect transistor (FinFET). However, this is not intended to be limiting and the GPU(s) 708 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 708 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 708 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 708 to access the CPU(s) 706 page tables directly. In such examples, when the GPU(s) 708 memory management unit (MMU) experiences a miss, an address translation request may be transmitted to the CPU(s) 706. In response, the CPU(s) 706 may look in its page tables for the virtual-to-physical mapping for the address and transmits the translation back to the GPU(s) 708. As such, unified memory technology may allow a single unified virtual address space for memory of both the CPU(s) 706 and the GPU(s) 708, thereby simplifying the GPU(s) 708 programming and porting of applications to the GPU(s) 708.

In addition, the GPU(s) 708 may include an access counter that may keep track of the frequency of access of the GPU(s) 708 to memory of other processors. The access counter may help ensure that memory pages are moved to the physical memory of the processor that is accessing the pages most frequently.

The SoC(s) 704 may include any number of cache(s) 712, including those described herein. For example, the cache(s) 712 may include an L3 cache that is available to both the CPU(s) 706 and the GPU(s) 708 (e.g., that is connected both the CPU(s) 706 and the GPU(s) 708). The cache(s) 712 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 704 may include an arithmetic logic unit(s) (ALU(s)) which may be leveraged in performing processing with respect to any of the variety of tasks or operations of the vehicle 700—such as processing DNNs. In addition, the SoC(s) 704 may include a floating point unit(s) (FPU(s))—or other math coprocessor or numeric coprocessor types—for performing mathematical operations within the system. For example, the SoC(s) 704 may include one or more FPUs integrated as execution units within a CPU(s) 706 and/or GPU(s) 708.

The SoC(s) 704 may include one or more accelerators 714 (e.g., hardware accelerators, software accelerators, or a combination thereof). For example, the SoC(s) 704 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 708 and to off-load some of the tasks of the GPU(s) 708 (e.g., to free up more cycles of the GPU(s) 708 for performing other tasks). As an example, the accelerator(s) 714 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 714 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 708, and by using an inference accelerator, for example, a designer may target either the DLA(s) or the GPU(s) 708 for any function. For example, the designer may focus processing of CNNs and floating point operations on the DLA(s) and leave other functions to the GPU(s) 708 and/or other accelerator(s) 714.

The accelerator(s) 714 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 706. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 714 (e.g., the hardware acceleration cluster) may include a computer vision network on-chip and SRAM, for providing a high-bandwidth, low latency SRAM for the accelerator(s) 714. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 704 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 714 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 766 output that correlates with the vehicle 700 orientation, distance, 3D location estimates of the object obtained from the neural network and/or other sensors (e.g., LiDAR sensor(s) 764 or RADAR sensor(s) 760), among others.

The SoC(s) 704 may include data store(s) 716 (e.g., memory). The data store(s) 716 may be on-chip memory of the SoC(s) 704, which may store neural networks to be executed on the GPU and/or the DLA. In some examples, the data store(s) 716 may be large enough in capacity to store multiple instances of neural networks for redundancy and safety. The data store(s) 712 may comprise L2 or L3 cache(s) 712. Reference to the data store(s) 716 may include reference to the memory associated with the PVA, DLA, and/or other accelerator(s) 714, as described herein.

The SoC(s) 704 may include one or more processor(s) 710 (e.g., embedded processors). The processor(s) 710 may include a boot and power management processor that may be a dedicated processor and subsystem to handle boot power and management functions and related security enforcement. The boot and power management processor may be a part of the SoC(s) 704 boot sequence and may provide runtime power management services. The boot power and management processor may provide clock and voltage programming, assistance in system low power state transitions, management of SoC(s) 704 thermals and temperature sensors, and/or management of the SoC(s) 704 power states. Each temperature sensor may be implemented as a ring-oscillator whose output frequency is proportional to temperature, and the SoC(s) 704 may use the ring-oscillators to detect temperatures of the CPU(s) 706, GPU(s) 708, and/or accelerator(s) 714. If temperatures are determined to exceed a threshold, the boot and power management processor may enter a temperature fault routine and put the SoC(s) 704 into a lower power state and/or put the vehicle 700 into a chauffeur to safe stop mode (e.g., bring the vehicle 700 to a safe stop).

The processor(s) 710 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 710 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 710 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 710 may further include a real-time camera engine that may include a dedicated processor subsystem for handling real-time camera management.

The processor(s) 710 may further include a high-dynamic range signal processor that may include an image signal processor that is a hardware engine that is part of the camera processing pipeline.

The processor(s) 710 may include a video image compositor that may be a processing block (e.g., implemented on a microprocessor) that implements video post-processing functions needed by a video playback application to produce the final image for the player window. The video image compositor may perform lens distortion correction on wide-view camera(s) 770, surround camera(s) 774, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 708 is not required to continuously render new surfaces. Even when the GPU(s) 708 is powered on and active doing 3D rendering, the video image compositor may be used to offload the GPU(s) 708 to improve performance and responsiveness.

The SoC(s) 704 may further include a mobile industry processor interface (MIPI) camera serial interface for receiving video and input from cameras, a high-speed interface, and/or a video input block that may be used for camera and related pixel input functions. The SoC(s) 704 may further include an input/output controller(s) that may be controlled by software and may be used for receiving I/O signals that are uncommitted to a specific role.

The SoC(s) 704 may further include a broad range of peripheral interfaces to enable communication with peripherals, audio codecs, power management, and/or other devices. The SoC(s) 704 may be used to process data from cameras (e.g., connected over Gigabit Multimedia Serial Link and Ethernet), sensors (e.g., LiDAR sensor(s) 764, RADAR sensor(s) 760, etc. that may be connected over Ethernet), data from bus 702 (e.g., speed of vehicle 700, steering wheel position, etc.), data from GNSS sensor(s) 758 (e.g., connected over Ethernet or CAN bus). The SoC(s) 704 may further include dedicated high-performance mass storage controllers that may include their own DMA engines, and that may be used to free the CPU(s) 706 from routine data management tasks.

The SoC(s) 704 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 704 may be faster, more reliable, and even more energy-efficient and space-efficient than conventional systems. For example, the accelerator(s) 714, when combined with the CPU(s) 706, the GPU(s) 708, and the data store(s) 716, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 720) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex. The DLA may further utilize metrics associated with sensor performance as input into one or more neural networks.

As another example, multiple neural networks may be run simultaneously, as is required for Level 3, 4, or 7 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 708.

In some examples, a CNN for facial recognition and vehicle owner identification may use data from camera sensors to identify the presence of an authorized driver and/or owner of the vehicle 700. The always on sensor processing engine may be used to unlock the vehicle when the owner approaches the driver door and turn on the lights, and, in security mode, to disable the vehicle when the owner leaves the vehicle. In this way, the SoC(s) 704 provide for security against theft and/or carjacking.

In another example, a CNN for emergency vehicle detection and identification may use data from microphones 796 to detect and identify emergency vehicle sirens. In contrast to conventional systems, that use general classifiers to detect sirens and manually extract features, the SoC(s) 704 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 758. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 762, until the emergency vehicle(s) passes.

The vehicle may include a CPU(s) 718 (e.g., discrete CPU(s), or dCPU(s)), that may be coupled to the SoC(s) 704 via a high-speed interconnect (e.g., PCIe). The CPU(s) 718 may include an X86 processor, for example. The CPU(s) 718 may be used to perform any of a variety of functions, including arbitrating potentially inconsistent results between ADAS sensors and the SoC(s) 704, and/or monitoring the status and health of the controller(s) 736 and/or infotainment SoC 730, for example.

The vehicle 700 may include a GPU(s) 720 (e.g., discrete GPU(s), or dGPU(s)), that may be coupled to the SoC(s) 704 via a high-speed interconnect (e.g., NVIDIA's NVLINK). The GPU(s) 720 may provide additional artificial intelligence functionality, such as by executing redundant and/or different neural networks, and may be used to train and/or update neural networks based on input (e.g., sensor data) from sensors of the vehicle 700.

The vehicle 700 may further include the network interface 724 which may include one or more wireless antennas 726 (e.g., one or more wireless antennas for different communication protocols, such as a cellular antenna, a Bluetooth antenna, etc.). The network interface 724 may be used to enable wireless connectivity over the Internet with the cloud (e.g., with the server(s) 778 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 700 information about vehicles in proximity to the vehicle 700 (e.g., vehicles in front of, on the side of, and/or behind the vehicle 700). This functionality may be part of a cooperative adaptive cruise control functionality of the vehicle 700.

The network interface 724 may include a SoC that provides modulation and demodulation functionality and enables the controller(s) 736 to communicate over wireless networks. The network interface 724 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 700 may further include data store(s) 728 which may include off-chip (e.g., off the SoC(s) 704) storage. The data store(s) 728 may include one or more storage elements including RAM, SRAM, DRAM, VRAM, Flash, hard disks, and/or other components and/or devices that may store at least one bit of data.

The vehicle 700 may further include GNSS sensor(s) 758. The GNSS sensor(s) 758 (e.g., GPS, assisted GPS sensors, differential GPS (DGPS) sensors, etc.), to assist in mapping, perception, occupancy grid generation, and/or path planning functions. Any number of GNSS sensor(s) 758 may be used, including, for example and without limitation, a GPS using a USB connector with an Ethernet to Serial (RS-232) bridge.

The vehicle 700 may further include RADAR sensor(s) 760. The RADAR sensor(s) 760 may be used by the vehicle 700 for long-range vehicle detection, even in darkness and/or severe weather conditions. RADAR functional safety levels may be ASIL B. The RADAR sensor(s) 760 may use the CAN and/or the bus 702 (e.g., to transmit data generated by the RADAR sensor(s) 760) for control and to access object tracking data, with access to Ethernet to access raw data in some examples. A wide variety of RADAR sensor types may be used. For example, and without limitation, the RADAR sensor(s) 760 may be suitable for front, rear, and side RADAR use. In some example, Pulse Doppler RADAR sensor(s) are used.

The RADAR sensor(s) 760 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 760 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 700 surroundings at higher speeds with minimal interference from traffic in adjacent lanes. The other two antennae may expand the field of view, making it possible to quickly detect vehicles entering or leaving the vehicle's 700 lane.

Mid-range RADAR systems may include, as an example, a range of up to 760 m (front) or 80 m (rear), and a field of view of up to 42 degrees (front) or 750 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 700 may further include ultrasonic sensor(s) 762. The ultrasonic sensor(s) 762, which may be positioned at the front, back, and/or the sides of the vehicle 700, may be used for park assist and/or to create and update an occupancy grid. A wide variety of ultrasonic sensor(s) 762 may be used, and different ultrasonic sensor(s) 762 may be used for different ranges of detection (e.g., 2.5 m, 4 m). The ultrasonic sensor(s) 762 may operate at functional safety levels of ASIL B.

The vehicle 700 may include LiDAR sensor(s) 764. The LiDAR sensor(s) 764 may be used for object and pedestrian detection, emergency braking, collision avoidance, and/or other functions. The LiDAR sensor(s) 764 may be functional safety level ASIL B. In some examples, the vehicle 700 may include multiple LiDAR sensors 764 (e.g., two, four, six, etc.) that may use Ethernet (e.g., to provide data to a Gigabit Ethernet switch).

In some examples, the LiDAR sensor(s) 764 may be capable of providing a list of objects and their distances for a 360-degree field of view. Commercially available LiDAR sensor(s) 764 may have an advertised range of approximately 700 m, with an accuracy of 2 cm-3 cm, and with support for a 700 Mbps Ethernet connection, for example. In some examples, one or more non-protruding LiDAR sensors 764 may be used. In such examples, the LiDAR sensor(s) 764 may be implemented as a small device that may be embedded into the front, rear, sides, and/or corners of the vehicle 700. The LiDAR sensor(s) 764, in such examples, may provide up to a 120-degree horizontal and 35-degree vertical field-of-view, with a 200 m range even for low-reflectivity objects. Front-mounted LiDAR sensor(s) 764 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 700. Available 3D flash LiDAR systems include a solid-state 3D staring array LiDAR camera with no moving parts other than a fan (e.g., a non-scanning LiDAR device). The flash LiDAR device may use a 7 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 764 may be less susceptible to motion blur, vibration, and/or shock.

The vehicle may further include IMU sensor(s) 766. The IMU sensor(s) 766 may be located at a center of the rear axle of the vehicle 700, in some examples. The IMU sensor(s) 766 may include, for example and without limitation, an accelerometer(s), a magnetometer(s), a gyroscope(s), a magnetic compass(es), and/or other sensor types. In some examples, such as in six-axis applications, the IMU sensor(s) 766 may include accelerometers and gyroscopes, while in nine-axis applications, the IMU sensor(s) 766 may include accelerometers, gyroscopes, and magnetometers.

In some embodiments, the IMU sensor(s) 766 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 766 may enable the vehicle 700 to estimate heading without requiring input from a magnetic sensor by directly observing and correlating the changes in velocity from GPS to the IMU sensor(s) 766. In some examples, the IMU sensor(s) 766 and the GNSS sensor(s) 758 may be combined in a single integrated unit.

The vehicle may include microphone(s) 796 placed in and/or around the vehicle 700. The microphone(s) 796 may be used for emergency vehicle detection and identification, among other things.

The vehicle may further include any number of camera types, including stereo camera(s) 768, wide-view camera(s) 770, infrared camera(s) 772, surround camera(s) 774, long-range and/or mid-range camera(s) 798, and/or other camera types. The cameras may be used to capture image data around an entire periphery of the vehicle 700. The types of cameras used depends on the embodiments and requirements for the vehicle 700, and any combination of camera types may be used to provide the necessary coverage around the vehicle 700. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 7A and FIG. 7B.

The vehicle 700 may further include vibration sensor(s) 742. The vibration sensor(s) 742 may measure vibrations of components of the vehicle, such as the axle(s). For example, changes in vibrations may indicate a change in road surfaces. In another example, when two or more vibration sensors 742 are used, the differences between the vibrations may be used to determine friction or slippage of the road surface (e.g., when the difference in vibration is between a power-driven axle and a freely rotating axle).

The vehicle 700 may include an ADAS system 738. The ADAS system 738 may include a SoC, in some examples. The ADAS system 738 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 760, LiDAR sensor(s) 764, and/or a camera(s). The ACC systems may include longitudinal ACC and/or lateral ACC. Longitudinal ACC monitors and controls the distance to the vehicle immediately ahead of the vehicle 700 and automatically adjust the vehicle speed to maintain a safe distance from vehicles ahead. Lateral ACC performs distance keeping, and advises the vehicle 700 to change lanes when necessary. Lateral ACC is related to other ADAS applications such as LCA and CWS.

CACC uses information from other vehicles that may be received via the network interface 724 and/or the wireless antenna(s) 726 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 700), while the I2V communication concept provides information about traffic further ahead. CACC systems may include either or both I2V and V2V information sources. Given the information of the vehicles ahead of the vehicle 700, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 760, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 760, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 700 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 700 if the vehicle 700 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 760, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 700 is backing up. Some RCTW systems include AEB to ensure that the vehicle brakes are applied to avoid a crash. RCTW systems may use one or more rear-facing RADAR sensor(s) 760, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 700, the vehicle 700 itself must, in the case of conflicting results, decide whether to heed the result from a primary computer or a secondary computer (e.g., a first controller 736 or a second controller 736). For example, in some embodiments, the ADAS system 738 may be a backup and/or secondary computer for providing perception information to a backup computer rationality module. The backup computer rationality monitor may run a redundant diverse software on hardware components to detect faults in perception and dynamic driving tasks. Outputs from the ADAS system 738 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 704.

In other examples, ADAS system 738 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 738 may be fed into the primary computer's perception block and/or the primary computer's dynamic driving task block. For example, if the ADAS system 738 indicates a forward crash warning due to an object immediately ahead, the perception block may use this information when identifying objects. In other examples, the secondary computer may have its own neural network which is trained and thus reduces the risk of false positives, as described herein.

The vehicle 700 may further include the infotainment SoC 730 (e.g., an in-vehicle infotainment system (IVI)). Although illustrated and described as a SoC, the infotainment system may not be a SoC, and may include two or more discrete components. The infotainment SoC 730 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 700. For example, the infotainment SoC 730 may radios, disk players, navigation systems, video players, USB and Bluetooth connectivity, carputers, in-car entertainment, Wi-Fi, steering wheel audio controls, hands free voice control, a heads-up display (HUD), an HMI display 734, a telematics device, a control panel (e.g., for controlling and/or interacting with various components, features, and/or systems), and/or other components. The infotainment SoC 730 may further be used to provide information (e.g., visual and/or audible) to a user(s) of the vehicle, such as information from the ADAS system 738, autonomous driving information such as planned vehicle maneuvers, trajectories, surrounding environment information (e.g., intersection information, vehicle information, road information, etc.), and/or other information.

The infotainment SoC 730 may include GPU functionality. The infotainment SoC 730 may communicate over the bus 702 (e.g., CAN bus, Ethernet, etc.) with other devices, systems, and/or components of the vehicle 700. In some examples, the infotainment SoC 730 may be coupled to a supervisory MCU such that the GPU of the infotainment system may perform some self-driving functions in the event that the primary controller(s) 736 (e.g., the primary and/or backup computers of the vehicle 700) fail. In such an example, the infotainment SoC 730 may put the vehicle 700 into a chauffeur to safe stop mode, as described herein.

The vehicle 700 may further include an instrument cluster 732 (e.g., a digital dash, an electronic instrument cluster, a digital instrument panel, etc.). The instrument cluster 732 may include a controller and/or supercomputer (e.g., a discrete controller or supercomputer). The instrument cluster 732 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 730 and the instrument cluster 732. In other words, the instrument cluster 732 may be included as part of the infotainment SoC 730, or vice versa.

FIG. 7D is a system diagram for communication between cloud-based server(s) and the example autonomous vehicle 700 of FIG. 7A, in accordance with some embodiments of the present disclosure. The system 776 may include server(s) 778, network(s) 790, and vehicles, including the vehicle 700. The server(s) 778 may include a plurality of GPUs 784(A)-584(H) (collectively referred to herein as GPUs 784), PCIe switches 782(A)-582(H) (collectively referred to herein as PCIe switches 782), and/or CPUs 780(A)-580(B) (collectively referred to herein as CPUs 780). The GPUs 784, the CPUs 780, and the PCIe switches may be interconnected with high-speed interconnects such as, for example and without limitation, NVLink interfaces 788 developed by NVIDIA and/or PCIe connections 786. In some examples, the GPUs 784 are connected via NVLink and/or NVSwitch SoC and the GPUs 784 and the PCIe switches 782 are connected via PCIe interconnects. Although eight GPUs 784, two CPUs 780, and two PCIe switches are illustrated, this is not intended to be limiting. Depending on the embodiment, each of the server(s) 778 may include any number of GPUs 784, CPUs 780, and/or PCIe switches. For example, the server(s) 778 may each include eight, sixteen, thirty-two, and/or more GPUs 784.

The server(s) 778 may receive, over the network(s) 790 and from the vehicles, image data representative of images showing unexpected or changed road conditions, such as recently commenced road-work. The server(s) 778 may transmit, over the network(s) 790 and to the vehicles, neural networks 792, updated neural networks 792, and/or map information 794, including information regarding traffic and road conditions. The updates to the map information 794 may include updates for the HD map 722, such as information regarding construction sites, potholes, detours, flooding, and/or other obstructions. In some examples, the neural networks 792, the updated neural networks 792, and/or the map information 794 may have resulted from new training and/or experiences represented in data received from any number of vehicles in the environment, and/or based on training performed at a datacenter (e.g., using the server(s) 778 and/or other servers).

The server(s) 778 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 790, and/or the machine learning models may be used by the server(s) 778 to remotely monitor the vehicles.

In some examples, the server(s) 778 may receive data from the vehicles and apply the data to up-to-date real-time neural networks for real-time intelligent inferencing. The server(s) 778 may include deep-learning supercomputers and/or dedicated AI computers powered by GPU(s) 784, such as a DGX and DGX Station machines developed by NVIDIA. However, in some examples, the server(s) 778 may include deep learning infrastructure that use only CPU-powered datacenters.

The deep-learning infrastructure of the server(s) 778 may be capable of fast, real-time inferencing, and may use that capability to evaluate and verify the health of the processors, software, and/or associated hardware in the vehicle 700. For example, the deep-learning infrastructure may receive periodic updates from the vehicle 700, such as a sequence of images and/or objects that the vehicle 700 has located in that sequence of images (e.g., via computer vision and/or other machine learning object classification techniques). The deep-learning infrastructure may run its own neural network to identify the objects and compare them with the objects identified by the vehicle 700 and, if the results do not match and the infrastructure concludes that the AI in the vehicle 700 is malfunctioning, the server(s) 778 may transmit a signal to the vehicle 700 instructing a fail-safe computer of the vehicle 700 to assume control, notify the passengers, and complete a safe parking maneuver.

For inferencing, the server(s) 778 may include the GPU(s) 784 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). In other words, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

In various embodiments, one or more CPU(s) 806, GPU(s) 808, and/or logic unit(s) 820 are configured to execute one or more instances of training engine 122 and/or execution engine 124. The execution engine 124 can be used to generate one or more track-object associations 246 from input images 210. The track-object associations 246 can then be used by the trajectory generator 432 to generate a trajectory 434, which can then be used to perform additional processing such as planning and control functions.

The communication interface 810 may include one or more receivers, transmitters, and/or transceivers that enable the computing device 800 to communicate with other computing devices via an electronic communication network, included wired and/or wireless communications. The communication interface 810 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may enable the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail herein) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that enable detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to enable the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-716(N), where “N” represents any whole, positive integer. In at least one embodiment, node C.R.s 916(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-716(N) may correspond to a server having one or more of the above-mentioned computing resources. In addition, in some embodiments, the node C.R.s 916(1)-716(N) may include one or more virtual components, such as vGPUs, vCPUs, and/or the like, and/or one or more of the node C.R.s 916(1)-716(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-716(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 933, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 933 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 933. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-716(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-716(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described herein with respect to the data center 900. In at least one embodiment, trained or deployed machine learning models corresponding to one or more neural networks may be used to infer or predict information using resources described herein with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described herein may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

In sum, an object tracking system detects objects depicted in input images and generate track queries, which represent the identities and positions of the objects and can be used to track the objects across input images captured at different times in a sequence. A set of “object queries” is provided as input to a transformer decoder, which identifies one or more objects in an input image for each of the object queries and transforms the object queries to object embeddings for each identified object. Each object embedding includes a position, e.g., of a cuboid or a bounding box, and a class of the corresponding object. The object tracking system uses a set of “track queries” to represent object tracking information for the identified objects. A track query is generated for each object detected in an input image. The track query for an object represents the appearance and motion that the object is predicted to have in a next image in the sequence. The predicted appearance portion of the track query is based on the embedding of the object that is associated with the track query, and can be a weighted average of the object embedding and the appearance portion of a previous track query for a previous image. The predicted motion portion is based on a sum of a position of the previous track query and a velocity of the detected object, and an amount of time between the previous input image and the current input image.

A self-attention network is used to enhance the object embeddings by identifying interactions between objects and tracks represented by the object embeddings, and increasing the values of object embedding weights that represent the interactions. The system calculates an affinity value for each object embedding based on one or more characteristics of the object embedding and one or more characteristics of the respective track query that corresponds to the object embedding. The affinity value is based on a sum of an appearance affinity value and a motion affinity value. The appearance affinity value represents a degree of similarity between the appearance portion of the track query and an appearance embedding derived from object embedding that corresponds to the track query. The motion affinity value represents a degree of similarity between the motion portion of the track query and a motion embedding derived from the object embedding that corresponds to the track query.

The system predicts an affinity matrix based on the calculated affinity values via a feed-forward neural network. The affinity matrix specifies affinity values between the objects and tracks. Each element of the affinity matrix specifies an affinity between one of the tracks and one of the objects. The system uses the affinity matrix to determine a one-to-one association between the tracks and the objects that maximizes the sum of the affinities, e.g., using a maximum weight bipartite graph matching technique. The association between tracks and objects can be used to perform multi-object tracking by follows particular object identities across input images of a video segment, since the objects in different images that are instances of the same object identity are associated with the same track for each image in which the objects appear.

Each element of the affinity matrix specifies the calculated affinity between one of the tracks and one of the objects. The association between tracks and objects is generated by determining a one-to-one assignment of tracks to objects that maximizes the sum of the affinities, e.g., using a maximum weight bipartite graph matching technique. The learned association between tracks and objects can be used to perform multi-object tracking, since each track is associated with an object of the same identity across images.

One technical advantage of the disclosed techniques relative to the prior art is increased accuracy of object detection and tracking in the 3D domain as a result of using object queries for the object detection task and using track queries for the object tracking task. Prior transformer-based approaches use a track query to represent both detection information for object detection tasks and tracking information for object tracking tasks. However, there is a conflict between the object detection task and the object tracking task that reduces the effectiveness of training the transformer networks. For object detection, the networks are trained to treat two object queries having the same object class as being similar, so two object queries having the same object class but different identities are treated as being similar in the object detection task. For object tracking, two track queries having the same object class should be treated as different objects if they have different identities. By decoupling object queries from track queries, the disclosed techniques enable networks to be trained to treat object queries having the same object class as being similar while treating track queries having the same object class and different identities as being different. Accordingly, decoupling object queries from track queries avoids the conflict between the representational conflict between the goals of object detection and object tracking and results in greater detection accuracy.
1. In some embodiments, a method comprises generating, using one or more processing units, one or more first encoded image features based on a first image; generating a plurality of first object embeddings based on the first encoded image features, wherein at least one first object embedding of the plurality of first object embeddings corresponds to a different object depicted in the first image; determining, using a first track query of one or more track queries and one or more machine learning operations, a first association between a first track and a first object that corresponds to the at least one first object embedding, wherein the first track corresponds to the first track query; and computing, based on the first association, an object trajectory associating the first track with the first object.
2. The method of clause 1, further comprising: updating the first track query based on the first association between the first track and the first object; determining a second association between the first track and a second object that corresponds to a second object embedding of the plurality of first object embeddings using the first track query, wherein the first track corresponds to the first track query, and the first and second objects correspond to the same object identity; and updating, based on the second association, the object trajectory to further associate the first track with the second object.
3. The method of clauses 1 or 2, wherein the determining, using a first track query of one or more track queries and the one or more machine learning operations, the first association comprises: generating, via execution of a self-attention neural network, one or more interacted embeddings based on the plurality of first object embeddings.
4. The method of any of clauses 1-3, wherein the one or more interacted embeddings are processed via a third feed-forward neural network that updates the one or more interacted embeddings.
5. The method of any of clauses 1-4, wherein the determining, using a first track query of one or more track queries and one or more machine learning operations, the first association further comprises: determining one or more affinity features, wherein at least one affinity feature of the one or more affinity features is determined based on a respective interacted embedding from the one or more interacted embeddings and a respective track query from the one or more track queries, wherein the first association is further determined based on the one or more affinity features.
6. The method of any of clauses 1-5, wherein the determining, using a first track query of one or more track queries and one or more machine learning operations, the first association further comprises: generating, via execution of a feed-forward neural network and based on the one or more affinity features, an affinity matrix in which at least one matrix element of the affinity matrix specifies an affinity score that characterizes an affinity between a track from the one or more tracks and an object from the one or more first objects, wherein the first association is determined based on the affinity matrix.
7. The method of any of clauses 1-6, wherein the determining, using a first track query of one or more track queries and one or more machine learning operations, the first association further comprises: generating, via execution of a first feed-forward neural network, one or more encoded object embeddings based on the one or more first object embeddings; generating, via execution of a second feed-forward neural network, one or more encoded track embeddings based on the one or more first object embeddings, wherein the self-attention neural network generates the one or more interacted embeddings based on the one or more encoded object embeddings and the one or more encoded track embeddings.
8. The method of any of clauses 1-7, wherein the one or more interacted embeddings generated by the self-attention neural network are further based on interactions in the self-attention neural network between a first feature of a first object in the encoded object embeddings and one or more second objects in the encoded object embeddings, and the self-attention neural network establishes at least one relationship between the first feature and at least one candidate track in the one or more track embeddings.
9. The method of any of clauses 1-8, wherein the one or more interacted embeddings include one or more candidate track embeddings, and wherein the at least one track query includes an object position embedding, the method further comprising: generating one or more updated track query motion portions based on the one or more track queries, wherein an object position in at least one updated track query motion portion is based on a predicted velocity specified by a respective object embedding of the one or more first object embeddings; and generating an updated track query based on the one or more updated track query motion portions.
10. The method of any of clauses 1-9, wherein the at least one track query further includes an object appearance embedding, the method further comprising: generating an updated track query appearance portion based on a moving average of appearance, wherein the moving average of appearance is determined based on the one or more track queries, the candidate track embeddings, and the affinity matrix, wherein the updated track query is further based on the updated track query appearance portion.
11. The method of any of clauses 1-10, wherein the one or more interacted embeddings include one or more first interacted embeddings for appearance affinity determination and one or more second interacted embeddings for motion affinity determination, and wherein the determining, using a first track query of the one or more track queries and one or more machine learning operations, the first association further comprises: determining one or more appearance queries and one or more motion queries based on the one or more track queries; generating one or more appearance affinity features based on the one or more appearance queries and the one or more first interacted embeddings for appearance affinity determination; and generating one or more motion affinity features based on the one or more motion queries.
12. The method of any of clauses 1-11, wherein the determining, using a first track query of one or more track queries one or more machine learning operations, the first association further comprises: generating, by executing a feed-forward neural network and based on the one or more appearance affinity features and the one or more motion affinity features, an affinity matrix in which at least one matrix element of the affinity matrix specifies an affinity score representing an affinity between a track in a plurality of tracks and an object in a plurality of objects, wherein the track is associated with a track query and the object is associated with an object query; and identifying, using bipartite matching and based on the affinity matrix, the first association between the one or more tracks and the one or more first objects.
13. The method of any of clauses 1-12, wherein the first image is captured using a sensor of the computing device.
14. In some embodiments, a processor comprises one or more processing units to perform operations comprising: generating, using the one or more processing units, one or more first encoded image features based on a first image; generating a plurality of first object embeddings based on the first encoded image features, wherein at least one first object embedding of the plurality of first object embeddings corresponds to a different object depicted in the first image; determining, using a first track query of one or more track queries and one or more machine learning operations, a first association between a first track and a first object that corresponds to the first object embedding, wherein the first track corresponds to the first track query; and computing, based on the first association, an object trajectory associating the first track with the first object.
15. The processor of clause 14, the operations further comprising: updating the first track query based on the first association between the first track and the first object; determining a second association between the first track and a second object that corresponds to a second object embedding of the plurality of first object embeddings using the first track query, wherein the first track corresponds to the first track query, and the first and second objects correspond to the same object identity; and updating, based on the second association, the object trajectory to further associate the first track with the second object.
16. The processor of clauses 14 or 15, wherein the determining, using a first track query of one or more track queries and the one or more machine learning operations, the first association comprises: generating, via execution of a self-attention neural network, one or more interacted embeddings based on the plurality of first object embeddings.
17. The processor of any of clauses 1-14, wherein the determining, using a first track query of one or more track queries and one or more machine learning operations, the first operations further comprises: determining one or more affinity features, wherein at least one affinity feature of the one or more affinity features is determined based on a respective interacted embedding from the one or more interacted embeddings and a respective track query from the one or more track queries, wherein the first association is further determined based on the one or more affinity features.
18. In some embodiments, a system comprises: one or more processors to perform operations comprising: generating, using the one or more processors, one or more first encoded image features based on a first image; generating a plurality of first object embeddings based on the first encoded image features, wherein at least one first object embedding of the plurality of first object embeddings corresponds to a different object depicted in the first image; determining, using a first track query of one or more first track queries and one or more machine learning operations, a first association between a first track and a first object that corresponds to the at least one first object embedding, wherein the first track corresponds to the first track query; and computing, based on the first association, an object trajectory associating the first track with the first object.
19. The system of clause 18, the operations further comprising: updating the first track query based on the first association between the first track and the first object.
20. The system of clauses 18 or 19, wherein the system comprises at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system for generating or presenting at least one of virtual reality content, augmented reality content, or mixed reality content; a system implemented using a robot; a system for performing conversational AI operations; a system implementing one or more large language models (LLMs); a system for generating synthetic data; a system incorporating one or more virtual machines (VMs); a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

1. A method, comprising:
generating, using one or more processing units, one or more first encoded image features based on a first image;
generating a plurality of first object embeddings based on the first encoded image features, wherein at least one first object embedding of the plurality of first object embeddings corresponds to a different object depicted in the first image;
determining, using a first track query of one or more track queries and one or more machine learning operations, a first association between a first track and a first object that corresponds to the at least one first object embedding, wherein the first track corresponds to the first track query; and
computing, based on the first association, an object trajectory associating the first track with the first object.

2. The method of claim 1, further comprising:
updating the first track query based on the first association between the first track and the first object;
determining a second association between the first track and a second object that corresponds to a second object embedding of the plurality of first object embeddings using the first track query, wherein the first track corresponds to the first track query, and the first and second objects correspond to the same object identity; and
updating, based on the second association, the object trajectory to further associate the first track with the second object.

3. The method of claim 1, wherein the determining, using a first track query of one or more track queries and the one or more machine learning operations, the first association comprises:
generating, via execution of a self-attention neural network, one or more interacted embeddings based on the plurality of first object embeddings.

4. The method of claim 3, wherein the one or more interacted embeddings are processed via a third feed-forward neural network that updates the one or more interacted embeddings.

5. The method of claim 3, wherein the determining, using a first track query of one or more track queries and one or more machine learning operations, the first association further comprises:
determining one or more affinity features, wherein at least one affinity feature of the one or more affinity features is determined based on a respective interacted embedding from the one or more interacted embeddings and a respective track query from the one or more track queries,
wherein the first association is further determined based on the one or more affinity features.

6. The method of claim 5, wherein the determining, using a first track query of one or more track queries and one or more machine learning operations, the first association further comprises:
generating, via execution of a feed-forward neural network and based on the one or more affinity features, an affinity matrix in which at least one matrix element of the affinity matrix specifies an affinity score that characterizes an affinity between a track from the one or more tracks and an object from the one or more first objects,
wherein the first association is determined based on the affinity matrix.

7. The method of claim 3, wherein the determining, using a first track query of one or more track queries and one or more machine learning operations, the first association further comprises:
generating, via execution of a first feed-forward neural network, one or more encoded object embeddings based on the one or more first object embeddings;
generating, via execution of a second feed-forward neural network, one or more encoded track embeddings based on the one or more first object embeddings,
wherein the self-attention neural network generates the one or more interacted embeddings based on the one or more encoded object embeddings and the one or more encoded track embeddings.

8. The method of claim 7, wherein the one or more interacted embeddings generated by the self-attention neural network are further based on interactions in the self-attention neural network between a first feature of a first object in the encoded object embeddings and one or more second objects in the encoded object embeddings, and the self-attention neural network establishes at least one relationship between the first feature and at least one candidate track in the one or more track embeddings.

9. The method of claim 7, wherein the one or more interacted embeddings include one or more candidate track embeddings, and wherein the at least one track query includes an object position embedding, the method further comprising:
generating one or more updated track query motion portions based on the one or more track queries, wherein an object position in at least one updated track query motion portion is based on a predicted velocity specified by a respective object embedding of the one or more first object embeddings; and
generating an updated track query based on the one or more updated track query motion portions.

10. The method of claim 9, wherein the at least one track query further includes an object appearance embedding, the method further comprising:
generating an updated track query appearance portion based on a moving average of appearance, wherein the moving average of appearance is determined based on the one or more track queries, the candidate track embeddings, and the affinity matrix,
wherein the updated track query is further based on the updated track query appearance portion.

11. The method of claim 3, wherein the one or more interacted embeddings include one or more first interacted embeddings for appearance affinity determination and one or more second interacted embeddings for motion affinity determination, and wherein the determining, using a first track query of the one or more track queries and one or more machine learning operations, the first association further comprises:
determining one or more appearance queries and one or more motion queries based on the one or more track queries;
generating one or more appearance affinity features based on the one or more appearance queries and the one or more first interacted embeddings for appearance affinity determination; and
generating one or more motion affinity features based on the one or more motion queries.

12. The method of claim 11, wherein the determining, using a first track query of one or more track queries one or more machine learning operations, the first association further comprises:
generating, by executing a feed-forward neural network and based on the one or more appearance affinity features and the one or more motion affinity features, an affinity matrix in which at least one matrix element of the affinity matrix specifies an affinity score representing an affinity between a track in a plurality of tracks and an object in a plurality of objects, wherein the track is associated with a track query and the object is associated with an object query; and
identifying, using bipartite matching and based on the affinity matrix, the first association between the one or more tracks and the one or more first objects.

13. The method of claim 1, wherein the first image is captured using a sensor of the computing device.

14. A processor comprising:
one or more processing units to perform operations comprising:
generating, using the one or more processing units, one or more first encoded image features based on a first image;
generating a plurality of first object embeddings based on the first encoded image features, wherein at least one first object embedding of the plurality of first object embeddings corresponds to a different object depicted in the first image;
determining, using a first track query of one or more track queries and one or more machine learning operations, a first association between a first track and a first object that corresponds to the first object embedding, wherein the first track corresponds to the first track query; and
computing, based on the first association, an object trajectory associating the first track with the first object.

15. The processor of claim 14, the operations further comprising:
updating the first track query based on the first association between the first track and the first object;
determining a second association between the first track and a second object that corresponds to a second object embedding of the plurality of first object embeddings using the first track query, wherein the first track corresponds to the first track query, and the first and second objects correspond to the same object identity; and
updating, based on the second association, the object trajectory to further associate the first track with the second object.

16. The processor of claim 14, wherein the determining, using a first track query of one or more track queries and the one or more machine learning operations, the first association comprises:
generating, via execution of a self-attention neural network, one or more interacted embeddings based on the plurality of first object embeddings.

17. The processor of claim 14, wherein the determining, using a first track query of one or more track queries and one or more machine learning operations, the first operations further comprises:
determining one or more affinity features, wherein at least one affinity feature of the one or more affinity features is determined based on a respective interacted embedding from the one or more interacted embeddings and a respective track query from the one or more track queries,
wherein the first association is further determined based on the one or more affinity features.

18. A system comprising:
one or more processors to perform operations comprising:
generating, using the one or more processors, one or more first encoded image features based on a first image;
generating a plurality of first object embeddings based on the first encoded image features, wherein at least one first object embedding of the plurality of first object embeddings corresponds to a different object depicted in the first image;
determining, using a first track query of one or more first track queries and one or more machine learning operations, a first association between a first track and a first object that corresponds to the at least one first object embedding, wherein the first track corresponds to the first track query; and
computing, based on the first association, an object trajectory associating the first track with the first object.

19. The system of claim 18, the operations further comprising:
updating the first track query based on the first association between the first track and the first object.

20. The system of claim 18, wherein the system comprises at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, augmented reality content, or mixed reality content;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.
